(19) United States
(12) Patent Application Publication
(10) Pub. No.: US 2012/0307369 A1
(43) Pub. Date: Dec. 6, 2012

(54) OMNIDIRECTIONAL REFLECTOR

(75) Inventors: Debasish Banerjee, Ann Arbor, MI (US); Minjuan Zhang, Ann Arbor, MI (US); Songtao Wu, Ann Arbor, MI (US); Masahiko Ishii, Okazaki City (JP)

(73) Assignees: Toyota Motor Corporation, Toyota Aichi (JP); Toyota Motor Engineering & Manufacturing North America, Inc., Erlanger, KY (US)

(21) Appl. No.: 13/572,071

(22) Filed: Aug. 10, 2012

Related U.S. Application Data
(63) Continuation-in-part of application No. 13/021,730, filed on Feb. 5, 2011.
Application No. 13/021,730 is a continuation-in-part of application No. 11/837,529, filed on Aug. 12, 2007, now Pat. No. 7,903,339.
Application No. 11/837,529 is a continuation-in-part of application No. 12/793,772, filed on Jun. 4, 2010.

(51) Int. Cl. G06F 17/50; G02B 5/28

(52) U.S. Cl. 359/589; 703/1

(57) ABSTRACT

A process for designing and manufacturing an omnidirectional structural color (OSC) multilayer stack. The process can include providing a digital processor operable to execute at least one module and a table of index of refraction values corresponding to different materials that are usable for manufacturing an OSC multilayer stack. An initial design for the OSC multilayer stack can be provided and at least one additional layer is added to the initial design OSC multilayer stack to create a modified OSC multilayer stack. In addition, the thickness of each layer of the modified OSC multilayer stack is calculated using a merit function module until an optimized OSC multilayer stack has been calculated.

### CROSS REFERENCE TO RELATED APPLICATIONS

This application is a continuation-in-part and claims priority to U.S. patent application Ser. No. 13/021,730 filed Feb. 5, 2011, which is in turn a continuation-in-part and claims priority to U.S. patent application Ser. No. 11/837,529 filed Aug. 12, 2007, and U.S. patent application Ser. No. 12/793,772 filed Jun. 4, 2010, all three of which are incorporated in their entirety herein by reference.

### FIELD OF THE INVENTION

The present invention relates to an omnidirectional reflector, and in particular, to an omnidirectional reflector that is a structural color and is made from materials having relatively low indices of refraction.

### BACKGROUND OF THE INVENTION

Based on theoretical calculations of a one-dimensional (1-D) photonic crystal, design criteria for omnidirectional (angle independent) structural colors have been developed as taught in co-pending U.S. patent application Ser. No. 11/837,529 (U.S. Patent Application Publication No. 2009/0046368, hereafter '529). As taught in '529, FIG. 1a illustrates a graph of a range to mid-range ratio equal to 0.2% for transverse magnetic mode (TM) and transverse electric mode (TE) of electromagnetic radiation plotted as a function of high refractive index versus low refractive index. This figure also shows two data points: one corresponding to an “ideal” multilayer stack made from a first material with a refractive index of 2.8 and a second material with a refractive index of 2.5; and another one corresponding to an actual fabricated multilayer stack made from vacuum deposition of TiO₂ with a resulting refractive index of 2.3 and HfO₂ with a resulting refractive index of 2.0.

Turning to FIG. 1b, a plot of reflectance as a function of incident angle illustrates the omnidirectional properties exhibited by the ideal multilayer stack when viewed from angles between 0 and 90 degrees. In contrast, FIG. 1c illustrates a reduction in the omnidirectional properties exhibited by the actual fabricated multilayer stack, in particular a decrease in the angle-independent reflectance from 0-90 degrees to 0-60 degrees.

On a plot of reflectance versus wavelength, an angle independent band of reflected electromagnetic radiation is the common reflectance of a multilayer stack when view from angles between 0 and theta (θ) degrees as illustrated by the range of wavelengths indicated by the double headed arrow in FIG. 1d. For the purposes of the present invention, this band of angle independent reflected radiation is measured at the average of the full width at half maximum (FWHM) for the two reflectance curves (0° and θ°) and can hereafter be referred to as an omnidirectional band when viewed between angles of 0 and θ degrees. It is appreciated that the extent of omnidirectional reflection, that is θ, for FIGS. 1b and 1c is 90 and 60 degrees, respectively.

It is appreciated that fabricating omnidirectional structural colors with less than desired indices of refraction can result in less than desired angle independence reflection. In addition, fabricating omnidirectional structural colors with materials that exhibit relatively high indices of refraction can be cost prohibitive. Therefore, a multilayer stack that provides omnidirectional structural color and can be made from materials that have relatively low indices of refraction would be desirable.

### SUMMARY OF THE INVENTION

The present invention discloses an omnidirectional structural color (OSC) having a non-periodic layered structure. The OSC can include a multilayer stack that has an outer surface and at least two layers. The at least two layers can include at least one first index of refraction material layer A1 and at least one second index of refraction material layer B1. The at least A1 and B1 can be alternately stacked on top of each other with each layer having a predefined thickness d_{A1} and d_{B1}, respectively. The thickness d_{A1} is not generally equal to the thickness d_{B1} such that the multilayer stack has the non-periodic layered structure. In addition, the multilayer stack can have a first omnidirectional reflection band that reflects more than 50% of a narrow band of electromagnetic radiation of less than 500 nanometers when the outer surface is exposed to a generally broad band of electromagnetic radiation, such as white light, at angles between 0 and 45 degrees normal to the outer surface.

In some instances, at least one third index of refraction material layer C1 having a predefined thickness d_{C1} can be included. The at least A1, B1 and C1 can be alternately stacked on top of each other and the thickness d_{C1} can be generally not equal to d_{A1} and d_{B1}. In other instances, the multilayer stack can include at least one fourth index of refraction material layer D1 having a predefined thickness d_{D1}, with at least one A1, B1, C1 and D1 being alternately stacked on top of each other and the thickness d_{D1} not being generally equal to d_{A1}, d_{B1} and d_{C1}.

In still yet other instances, the multilayer stack can include at least one fifth index of refraction material layer E1 having a predefined thickness d_{E1}, with the at least A1, B1, C1, D1 and E1 being alternately stacked on top of each other and the thickness d_{E1} not being generally equal to d_{A1}, d_{B1}, d_{C1} and d_{D1}.

The first, second, third, fourth and/or fifth index of refraction materials can be selected from any material known to those skilled in the art that are used now, or can be used in the future, to produce multilayer structures having at least three layers. For example and for illustrative purposes only, the materials can include titanium oxide, silicon oxide, mica, zirconium oxide, niobium oxide, chromium, silver, and the like. In addition, it is appreciated that the invention is not limited to five different index of refraction material layers and can include any number of different materials so long as a desired design parameter for the OSC is achieved.

A process for omnidirectionally reflecting a narrow band of electromagnetic radiation is also disclosed with the process including an OSC as described above and providing a source of broadband electromagnetic radiation. Thereafter, the OSC is exposed to the broadband electromagnetic radiation at angles between 0 and 45 degrees normal to the outer surface of the multilayer stack with reflection of more than 50% of a narrow band of electromagnetic radiation less than 500 nanometers wide being provided.

In some instances, the OSC and the process provided herein can reflect more than 50% of a narrow band of electromagnetic radiation of less than 200 nanometers when the outer surface of the multilayer stack is exposed to a generally broad band of electromagnetic radiation at angles between 0 and 60 degrees normal to the outer surface. In other instances, an OSC and the process can reflect more than 50% of a narrow band of electromagnetic radiation of less than 200 nanometers when the outer surface is exposed to a generally broad band of electromagnetic radiation at angles between 0 and 80 degrees. In still other instances, more than 50% of a narrow band less than 100 nanometers is reflected when the outer surface is exposed at angles between 0 and 45 degrees normal thereto. An OSC disclosed herein can also reflect more than 50% of infrared electromagnetic radiation having a wavelength of less than 400 nanometers in addition to the narrow band reflected as described above.

A process for designing and manufacturing an OSC multilayer stack is also provided. The process can include providing a computer with a digital processor operable to execute at least one module and a table of index of refraction values corresponding to different materials that are usable for manufacturing an OSC multilayer stack. An initial design for the OSC multilayer stack can be provided and the initial design can have at least one layer with an index of refraction selected from the table of index of refraction values. At least one additional layer can be added to the initial design OSC multilayer stack to create a modified OSC multilayer stack, the at least one additional layer having the same or a different index of refraction as the at least one layer of the initial design. Thereafter, the thickness of each layer of the modified OSC multilayer stack is calculated using a merit function module until an optimized OSC multilayer stack has been calculated. In addition, the optimized OSC multilayer stack is operable to reflect a narrow band of electromagnetic radiation of less than 500 nanometers when viewed from angles between 0 to 45 degrees. In some instances, the process optimizes the OSC multilayer stack using needle optimization techniques.

The modified OSC multilayer stack can have a first layer with a first index of refraction and a second layer with a second index of refraction that is not equal to the first index of refraction. Furthermore, the modified OSC multilayer stack can have a third layer with a third index of refraction that is not equal to the first index of refraction or the second index of refraction.

The process can further include providing a first, second, and third material that have the first, second, and third indices of refraction, respectively, and manufacturing the OSC multilayer stack with the first, second, and third materials having the optimized thicknesses calculated with the merit function module. The optimized OSC multilayer can have seven or less total layers and reflect at least 75% of the narrow band of electromagnetic radiation as an equivalent 13-layer OSC multilayer stack. In some instances, the seven or less total layers have a chroma that is within 25% of the equivalent 13-layer OSC multilayer stack. In other instances, the seven or less total layers have a chroma within 10% of the equivalent 13-layer OSC multilayer stack. The optimized OSC multilayer can also have a hue shift that is within 25% of the equivalent 13-layer OSC multilayer stack and possibly have a hue shift within 10% of the equivalent 13-layer OSC multilayer stack.

### BRIEF DESCRIPTION OF THE DRAWINGS

FIG. 1a is a graphical representation illustrating a refractive index zone necessary for omnidirectional structural color;

FIG. 1b is a graphical representation of a calculated or ideal band structure showing complete omnidirectionality;

FIG. 1c is a graphical representation illustrating an actual band structure for a fabricated omnidirectional reflector;

FIG. 1d is a graphical representation illustrating an omnidirectional band for a multilayer stack;

FIG. 2 illustrates a three-layer structure made from two different materials and a corresponding single equivalent layer;

FIG. 3 illustrates an original prototype structure of an omnidirectional reflector and an equivalent layer design;

FIG. 4 is a graphical representation of reflectance versus wavelength for a 39-layer equivalent structure made from a first material and a second material replacing a 13-layer structure made from a low index of refraction material with a refractive index of 2.5 and a high index of refraction material with a refractive index of 2.89;

FIG. 5 illustrates an improved design concept of equivalent layer approximations;

FIG. 6 is a graphical representation of reflectance versus wavelength for a 39-layer structure that is equivalent to a 13-layer structure;

FIG. 7 is a graphical representation of the difference in maximum wavelength (ΔX) and maximum reflectance (ΔY) between the 39-layer structure and the 13-layer structure;

FIG. 8 is a plot of ΔX between a 13-layer periodic structure and an equivalent 13-layer non-periodic structure for a 0 and 45 degree incidence angles as a function of refraction index values for a low refraction index material and a high refractive index material;

FIG. 9 is a plot of ΔX between a 23-layer periodic structure and an equivalent 23-layer non-periodic structure for a 0 and 45 degree incidence angles as a function of refraction index values for a low refraction index material and a high refractive index material;

FIG. 10 is a plot of ΔY between a 13-layer periodic structure and an equivalent 13-layer non-periodic structure for a 0 and 45 degree incidence angles as a function of refraction index values for a low refraction index material and a high refractive index material;

FIG. 11 is a plot of ΔY between a 23-layer periodic structure and an equivalent 23-layer non-periodic structure for a 0 and 45 degree incidence angles as a function of refraction index values for a low refraction index material and a high refractive index material;

FIG. 12 is a plot of layer thickness and refractive indices for layers of a 13-layer non-periodic structure according to an embodiment of the present invention;

FIG. 13 is a plot of layer thickness and refractive indices for layers of a 23-layer non-periodic structure according to an embodiment of the present invention;

FIG. 14 is a schematic illustration representing improvements in omnidirectional structural color multilayer structures;

FIG. 15 is a schematic illustration of a multilayer stack according to an embodiment of the present invention;

FIG. 16 is a schematic flowchart of a process for making a multilayer stack according to an embodiment of the present invention;

FIG. 17 is: (A) a graphical representation for the thickness and material for each layer of a 7-layer TiO₂—SiO₂—ZrO₂ multilayer stack design; and (B) a corresponding graphical representation illustrating an omnidirectional band for the multilayer stack in (A);

FIG. 18 is: (A) a graphical representation for the thickness and material for each layer of an 8-layer TiO₂—SiO₂—ZrO₂ multilayer stack design; and (B) a corresponding graphical representation illustrating an omnidirectional band for the multilayer stack in (A);

FIG. 19 is: (A) a graphical representation for the thickness and material for each layer of a 10-layer TiO₂—SiO₂—ZrO₂ multilayer stack design; and (B) a corresponding graphical representation illustrating an omnidirectional band for the multilayer stack in (A);

FIG. 20 is: (A) a graphical representation for the thickness and material for each layer of an 11-layer TiO₂—ZrO₂—Cr—Nb₂O₅ multilayer stack design; and (B) a corresponding graphical representation illustrating an omnidirectional band for the multilayer stack in (A);

FIG. 21 is: (A) a graphical representation for the thickness and material for each layer of a 12-layer TiO₂—Ag—Cr—ZrO₂—Nb₂O₅ multilayer stack design; and (B) a corresponding graphical representation illustrating an omnidirectional band for the multilayer stack in (A);

FIG. 22 is: (A) a graphical representation for the thickness and material for each layer of a 13-layer TiO₂—Ag—Cr—ZrO₂—Nb₂O₅ multilayer stack design; and (B) a corresponding graphical representation illustrating an omnidirectional band for the multilayer stack in (A);

FIG. 23 is: (A) a graphical representation for the thickness and material for each layer of a 3-layer TiO₂—SiO₂ multilayer stack design; and (B) a corresponding graphical representation illustrating an omnidirectional band for the multilayer stack in (A);

FIG. 24 is: (A) a graphical representation for the thickness and material for each layer of a 5-layer TiO₂—SiO₂-Mica multilayer stack design; and (B) a corresponding graphical representation illustrating an omnidirectional band for the multilayer stack in (A);

FIG. 25 is: (A) a graphical representation for the thickness and material for each layer of a 7-layer TiO₂—SiO₂-Mica multilayer stack design; and (B) a corresponding graphical representation illustrating an omnidirectional band for the multilayer stack in (A);

FIG. 26 is: (A) a graphical representation for the thickness and material for each layer of a 10-layer TiO₂—SiO₂-Mica multilayer stack design; and (B) a corresponding graphical representation illustrating an omnidirectional band for the multilayer stack in (A);

FIG. 27 is a graphical representation of a P-function and insertion of additional layers within an OSC multilayer stack;

FIG. 28 is an illustration of a process according to an embodiment of the present invention;

FIG. 29 is a graphical representation of: (A) reflectance versus wavelength for 5-layer and 3-layer optimized SiO₂—TiO₂ OSC multilayer stacks compared to 31-layer and 13-layer equivalent HfO₂—TiO₂ multilayer stacks; (B) reflectance versus wavelength for 3-layer, 5-layer and 7-layer optimized SiO₂—TiO₂ OSC multilayer stacks compared to a 31-layer and 13-layer equivalent HfO₂—TiO₂ multilayer stacks; (C) reflectance versus wavelength for 3-layer, 5-layer, and 7-layer optimized SiO₂—TiO₂ OSC multilayer stacks compared to a 13-layer equivalent HfO₂—TiO₂ multilayer stack at viewing angles of 0 and 45 degrees; (D) thicknesses, chroma (C*), hue shift (H(ab)) and reflectance (Rmax) for the 3-layer optimized SiO₂—TiO₂ OSC multilayer stack; (E) thicknesses, chroma (C*), hue shift (H(ab)) and reflectance (Rmax) for the 5-layer optimized SiO₂—TiO₂-Mica OSC multilayer stack; and (F) thicknesses, chroma (C*), hue shift (H(ab)) and reflectance (Rmax) for the 7-layer optimized SiO₂—TiO₂-Mica OSC multilayer stack;

FIG. 30 is: (A) a graphical representation of reflectance versus wavelength for a 6-layer optimized SiO₂-Mica-ZnS OSC multilayer stack compared to the 13-layer equivalent HfO₂—TiO₂ multilayer stacks shown in FIG. 29 when viewed at 0 and 45 degrees; and (B) thicknesses, chroma (C*), hue shift (H(ab)) and reflectance (Rmax) for the 6-layer optimized SiO₂-Mica-ZnS OSC multilayer stack;

FIG. 31 is: (A) a graphical representation of reflectance versus wavelength for an 8-layer optimized TiO₂—Cr—ZnS—SiO₂—MgF₂ OSC multilayer stack compared to the 13-layer equivalent HfO₂—TiO₂ multilayer stacks shown in FIG. 29; (B) thicknesses, chroma (C*), hue shift (H(ab)) and reflectance (Rmax) for the 8-layer optimized TiO₂—Cr—ZnS—SiO₂—MgF₂ OSC multilayer stack; (C) a graphical representation of reflectance versus wavelength for a 6-layer optimized TiO₂—Cr—MgF₂—SiO₂ OSC multilayer stack compared to the 13-layer equivalent HfO₂—TiO₂ multilayer stacks shown in FIG. 29; and (D) thicknesses, chroma (C*), hue shift (H(ab)) and reflectance (Rmax) for the 6-layer optimized TiO₂—Cr—MgF₂—SiO₂ OSC multilayer stack;

FIG. 32 is: (A) a graphical representation of reflectance versus wavelength for a 5-layer optimized SiO₂—TiO₂—Cr OSC multilayer stack compared to the 13-layer equivalent HfO₂—TiO₂ multilayer stacks shown in FIG. 29 for viewing angles of 0 and 45 degrees; and (B) thicknesses, chroma (C*) and reflectance (Max R) for the 5-layer optimized SiO₂—TiO₂—Cr OSC multilayer stack;

FIG. 33 is: (A) a graphical representation of reflectance versus wavelength for a 5-layer optimized TiO₂—Cr—MgF₂ OSC multilayer stack compared to the 13-layer equivalent HfO₂—TiO₂ multilayer stacks shown in FIG. 29 for viewing angles of 0 and 45 degrees; and (B) thicknesses, chroma (C*) and reflectance (Max R) for the 5-layer optimized TiO₂—Cr—MgF₂ OSC multilayer stack;

FIG. 34 is: (A) a graphical representation of reflectance versus wavelength for a 1-layer, 2-layer, and 3-layer optimized ZnS—SiO₂ OSC multilayer stacks; (B) thickness and chroma (C*) for the 1-layer optimized ZnS OSC multilayer stack; (C) thicknesses and chroma (C*) for the 2-layer optimized ZnS—SiO₂ OSC multilayer stack; and (D) thicknesses and chroma (C*) for the 3-layer optimized ZnS—SiO₂ OSC multilayer stack; and

FIG. 35 is: (A) a graphical representation of reflectance versus wavelength for a 5-layer optimized ZrO₂—TiO₂—Nb₂O₅—SiO₂ OSC multilayer stack compared to the 13-layer equivalent HfO₂—TiO₂ multilayer stacks shown in FIG. 29 for viewing angles of 0 and 45 degrees; and (B) thicknesses, chroma (C*) and reflectance (Max R) for the 5-layer optimized ZrO₂—TiO₂—Nb₂O₅—SiO₂ OSC multilayer stack.

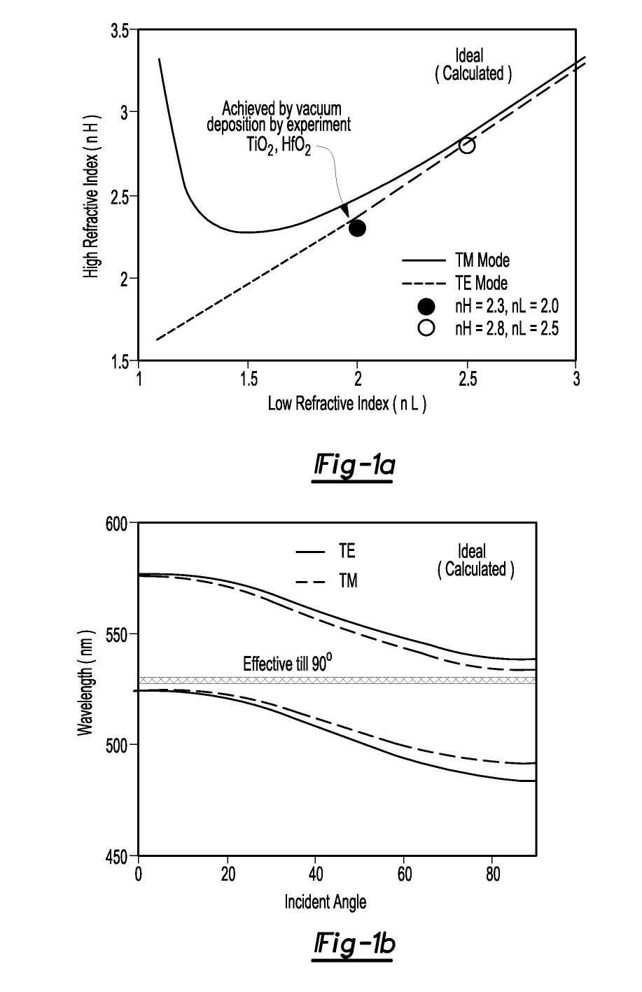

### DETAILED DESCRIPTION OF THE INVENTION

The present invention discloses an omnidirectional reflector that can reflect a band of electromagnetic radiation of less than 500 nanometers when viewed from angles between 0 and 45 degrees. Stated differently, the omnidirectional reflector has an omnidirectional band of less than 500 nanometers when viewed from angles between 0 and 45 degrees. The omnidirectional reflector can include a multilayer stack with a plurality of layers of a high index of refraction material and a plurality of layers of a low index of refraction material. The plurality of layers of high index of refraction material and low index of refraction material can be alternately stacked on top of and/or across each other and have thicknesses such that a non-periodic structure is provided. In some instances, the omnidirectional band is less than 200 nanometers when viewed from angles between 0 and 65 degrees and in other instances, omnidirectional band is less than 200 nanometers when viewed from angles between 0 and 80 degrees.

The high index of refraction material can have a refractive index between 1.5 and 2.6, inclusive, and the low index of refraction material can have an index of refraction between 0.75 and 2.0, inclusive. In some instances, the multilayer stack can have at least 2 total layers, while in other instances the multilayer stack can have at least 3 total layers. In still other instances, the multilayer stack can have at least 7 total layers. In still yet other instances, the multilayer stack has at least 13 layers, or in the alternative, at least 19 layers.

With regard to the non-periodic layered structure, the plurality of layers of high index of refraction material can be designated as H1, H2, H3 . . . Hn and the plurality of layers of low index of refraction material can be designated L1, L2, L3 . . . Lm, with the layers having predefined thicknesses designated as d_{H1}, d_{H2}, d_{H3} . . . d_{Hn}, and d_{L1}, d_{L2}, d_{L3} . . . d_{Lm}, respectively. In addition, the thickness d_{H1} is not generally equal to at least one of the thicknesses d_{H2}, d_{H3} or d_{Hn}, and the thickness d_{L1} is not generally equal to at least one of the thicknesses d_{L2}, d_{L3} or d_{Lm}. In some instances, the thickness d_{H1} is different than d_{H2} and d_{H3} and/or the thickness d_{L1} is different than d_{L2} and d_{L3}. In other instances, the thickness d_{H1} is different than d_{H2}, d_{H3} . . . and d_{Hn}, and/or the thickness d_{L1} is different than d_{L2}, d_{L3} . . . and d_{Lm}.

The multilayer stack can be in the form of a flake and the flake can have an average thickness range of between 0.5 and 5 microns and/or an average diameter of between 5 and 50 microns. The flake can be mixed with a binder to provide a paint and/or an ultraviolet protective coating.

A process for omnidirectionally reflecting a narrow band of electromagnetic radiation is also disclosed. The process includes providing a multilayer stack having a plurality of layers of high index of refraction material designated as H1, H2, H3 . . . Hn, and a plurality of layers of low index of refraction material designated L1, L2, L3 . . . Lm. The layers of different materials are alternately stacked on top of and/or across each other. The plurality of layers of high index of refraction material and low index of refraction material each have a predefined thickness designated as d_{H1}, d_{H2}, d_{H3} . . . dₘ, and d_{L1}, d_{L2}, d_{L3} . . . d_{Lm}, respectively, and the thickness d_{H1} can be different than d_{H2}, d_{H3} . . . and/or d_{Hn}, and the thickness d_{L1} can be different than d_{L2}, d_{L3} . . . and/or d_{Lm}. As such, the multilayer stack can have a non-periodic layered structure.

A source of broadband electromagnetic radiation is also provided and used to illuminate the multilayer stack. Thereafter, an omnidirectional band of less than 500 nanometers is reflected from the multilayer stack when viewed from angles between 0 and 45 degrees. In some instances, the omnidirectional band of less than 200 nanometers is angle independent when viewed from angles between 0 to 65 degrees, and in still other instances, when viewed from angles between 0 to 80 degrees. The omnidirectional band can be within the visible light region, or in the alternative, within the ultraviolet region or the infrared region. In addition, the multilayer stack can be in the form of a flake, and the flake may or may not be mixed with a binder to make a paint that is an omnidirectional structural color.

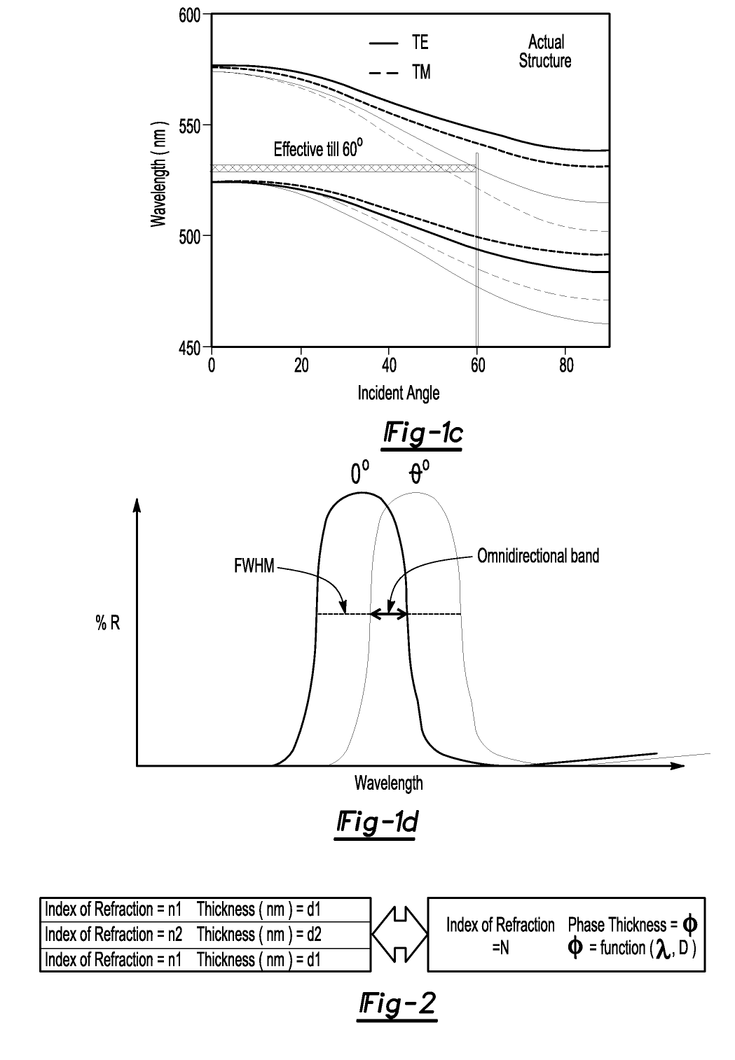

Not being bound by theory, development of an inventive multilayer stack is discussed below. A theory of equivalent layers developed during research of equivalent layer techniques, and not addressing omnidirectionality as in the instant invention, states that optical properties of a single material can be replicated by a symmetrical combination of a three-layer structure having preset high and low refractive indices of refraction (see Alexander V. Tikhonravov, Michael K. Trubetskov, Tatiana V. Amotchkina, and Alfred Thelen, “Optical coating design algorithm based on the equivalent layers theory” Appl. Optics, 45, 7, 1530, 2006). For example, a three-layer two-material structure with indices of refraction equal to n₁ and n₂, and having physical thicknesses of d₁ and d₂ that is equivalent to a single layer of material having an index of refraction of N and a thickness of D is illustrated in FIG. 2. A characteristic matrix (M) can completely describe all of the structures optical properties and Herpin's theorem states that the equivalent single-layer structure can have the same optical properties as the three-layer structure if an equivalent matrix (M_{E}) can be achieved.

A solution for M_{E} can result in a non-unique solution set which approximates the original structure. As such, expressions for M and M_{E} shown in Equations 1 and 2 below can be used to establish criteria for the existence of an equivalent 3-layer structure in which each matrix element of the two matrices M and M_{E} are equated to each other.

$$M = [ \begin{matrix}\begin{matrix}cos 2 {ϕ}_{1} * cos 2 {ϕ}_{2} - \\ p * sin 2 {ϕ}_{1} * sin 2 {ϕ}_{2}\end{matrix} & \frac{1}{{n}_{1}} ( \begin{matrix}sin 2 {ϕ}_{1} * cos 2 {ϕ}_{2} + \\ \begin{matrix}p * cos 2 {ϕ}_{1} * sin 2 {ϕ}_{2} + \\ q * sin 2 {ϕ}_{2}\end{matrix}\end{matrix} ) \\ {in}_{1} ( \begin{matrix}sin 2 {ϕ}_{1} * cos 2 {ϕ}_{2} + \\ p * cos 2 {ϕ}_{1} * sin 2 {ϕ}_{2} - \\ q * sin 2 {ϕ}_{2}\end{matrix} ) & \begin{matrix}cos 2 {ϕ}_{1} * cos 2 {ϕ}_{2} - \\ p * sin 2 {ϕ}_{1} * sin 2 {ϕ}_{2}\end{matrix}\end{matrix} ] \qquad ( 1 )$$

where:

$$p = \frac{1}{2} ( \frac{{n}_{1}}{{n}_{2}} + \frac{{n}_{2}}{{n}_{1}} ) , q = \frac{1}{2} ( \frac{{n}_{1}}{{n}_{2}} - \frac{{n}_{2}}{{n}_{1}} ) , {ϕ}_{1} = \frac{2 π}{λ} ( {n}_{1} {d}_{1} ) , \\ {ϕ}_{2} = \frac{2 π}{λ} ( {n}_{2} {d}_{2} ) , λ = reflected wavelength \\ {M}_{E} = [ \begin{matrix}cos Φ & \frac{1}{N} sin Φ \\ iN sin Φ & cos Φ\end{matrix} ] \qquad ( 2 )$$

In so doing, the following expressions of the structural parameters of the two materials used for the 3-layer structure can be derived:

$$\begin{matrix}cos Φ = cos 2 {ϕ}_{1} cos 2 {ϕ}_{2} - p sin 2 {ϕ}_{1} sin 2 {ϕ}_{2} & ( 3 ) \\ N = {n}_{1} \sqrt{\frac{sin 2 {ϕ}_{1} cos 2 {ϕ}_{2} + p cos 2 {ϕ}_{1} sin 2 {ϕ}_{2} - q sin 2 {ϕ}_{2}}{sin 2 {ϕ}_{1} cos 2 {ϕ}_{2} + p cos 2 {ϕ}_{1} sin 2 {ϕ}_{2} + q sin 2 {ϕ}_{2}}} & ( 4 )\end{matrix}$$

and original designs of ideal omnidirectional reflectors can be replicated with equivalent structures made from different starting materials.

An illustrative example of the use of the theory of equivalent layers to design and/or provide an omnidirectional structural color is discussed below.

### Example

Starting with a high index of refraction material with a refractive index of 2.89 and a low index of refraction material with a refractive index of 2.5, and using a quarter-wave thickness criterion, an expression for the thickness of the high index of refraction material d_{H} and the thickness of the low index of refraction material d_{L} for a given target wavelength λ can be calculated from Equation 4 below:

$${d}_{H} = \frac{λ}{4 {n}_{H}} , {d}_{L} = \frac{λ}{4 {n}_{L}} \qquad ( 4 )$$

Using a target wavelength of 575 nanometers, the layer thickness for the high index of refraction material is approximately 49.7 nanometers and the layer thickness for the low index of refraction material is approximately 57.5 nanometers. A resultant reflectance versus wavelength of such a structure can be generated using a one-dimensional (1-D) photonic calculator written for MATLAB. This calculator uses a matrix method to calculate the reflectivity, transmission, and absorptions of 1-D optically stratified medium.

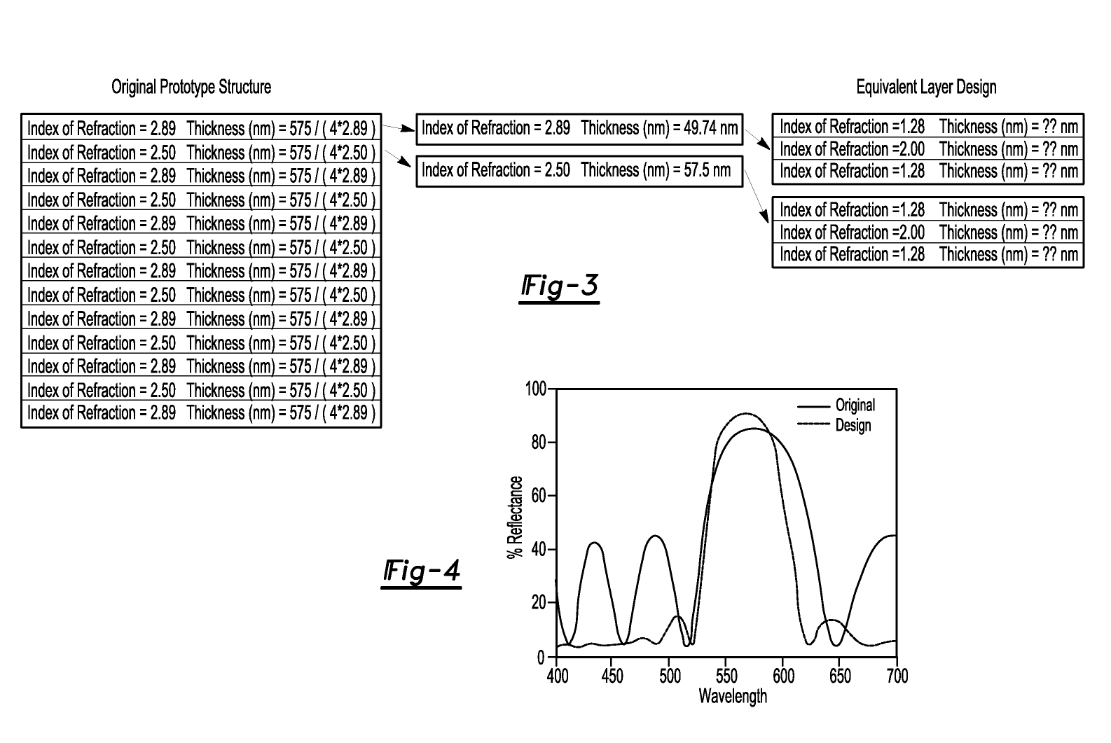

Regarding an equivalent design using different starting materials, a first material with a refractive index of 1.28 and a second material with a refractive index of 2.0 were assumed. In addition, an incident angle of 0 degrees for the illuminating electromagnetic radiation, natural light with 50% transverse electric and 50% transverse magnetic modes, a transfer medium of air and a substrate of glass were assumed. A schematic representation of the replacement of each original layer by three equivalent layers is shown in FIG. 3. As illustrated in this figure, the thicknesses of each equivalent layer used to replace each layer of the original prototype are values to be determined.

The simulation process is initiated with input of the indices of refraction for the high index of refraction material and the low index of refraction material of the original prototype. In addition, thicknesses of the two materials can be included and the 1-D photonic calculator can generate a reflectance versus wavelength plot.

With regard to providing three equivalent layers to match the optical properties of each single layer, optimization consists of varying the thicknesses of the individual equivalent layers—assuming the first layer and the third layer are equal—and comparing the resultant wavelength versus reflectance curve to the original reference. An example of a simulation for replacing each layer of an original 13-layer stack with three equivalent layers is shown in FIG. 4 where an entire 13-layer original reference structure as illustrated in FIG. 3 was replicated with three equivalent layers replacing each of the original layers. Therefore, a simulation for 13×3=39 layers was chosen as a starting structure with the thicknesses of the first material (n₁=1.28) and the second material (n₂=2.0) were varied from 1 to 500 nanometers. FIG. 4 illustrates that optimization of the equivalent 39-layer structure with a first material thickness of 99 nanometers and a second material thickness of 14 nanometers provided similar results for reflectance as a function of wavelength when compared to the original 13-layer structure. The equivalent 39-layer structure also resulted in a drastic reduction in the side bands that are present for the original 13-layer structure. As such, an original two-material 13-layer structure having a high index of refraction material with a refractive index of 2.89 and a low index of refraction material with a refractive index of 2.5 is shown to be replaceable with a two-material 39-layer structure having a high index of refraction material with a refractive index of 2.0 and a low index of refraction material with a refractive index of 1.28.

In an effort to provide additional flexibility with respect to materials selection and manufacturing techniques, the concept of uncoupling the layers during optimization calculations of the layer thicknesses is introduced. As such, the previous concept of replacing the layers of the original 13-layer stack with repeating equivalent 3-layer stacks is discarded and each layer has its own multiplier that determines the final thickness thereof. For example, a 39-layer structure can have 39 separate multiplier variables, and thus 39 layers, each having a different thickness.

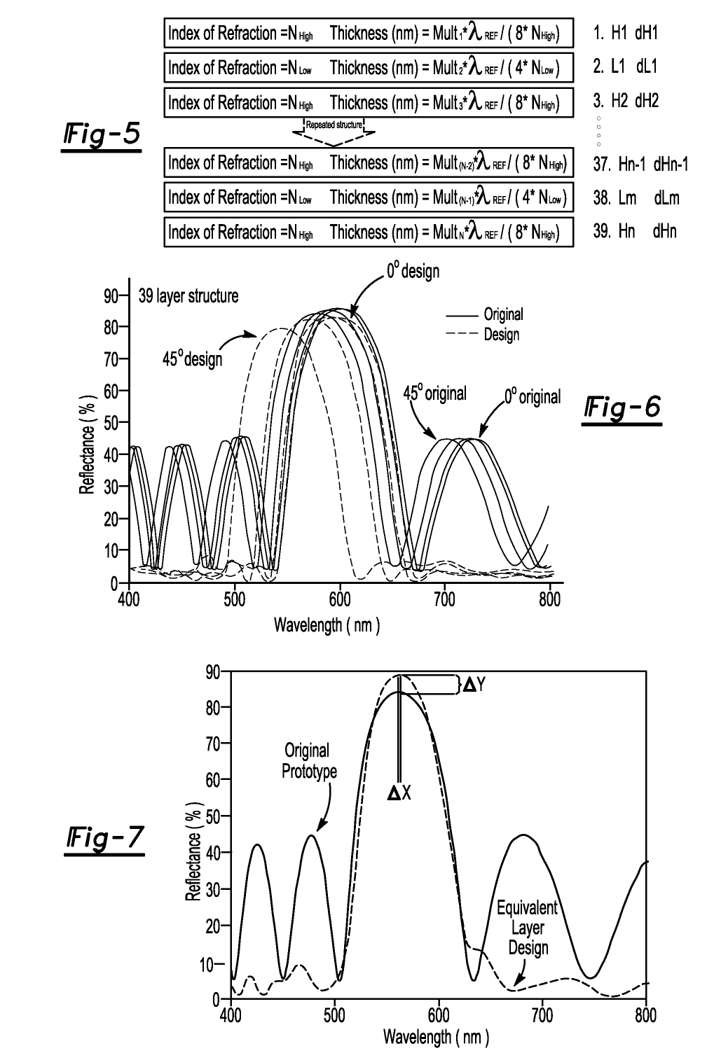

FIG. 5 illustrates a 39-layer structure where two materials are used, with one of the materials having a high index of refraction (N_{high}) and one of the materials having a low index of refraction (N_{low}). As shown in this figure, the thickness of each of these layers is equal to a multiplier (Multᵢ) times a reference wavelength divided by the respective index of refraction and either 4 or 8. In addition, the alternating layers of high index of refraction material are designated H1, H2, H3 . . . Hn and the alternating layers of low index of refraction material designated L1, L2, L3 . . . Lm. Furthermore, the layers each have a thickness designated as d_{H1}, d_{H2}, d_{H3} . . . d_{Hn}, and d_{L1}, d_{L2}, d_{L3} . . . d_{Lm} as shown in the figure. It is appreciated that it is not necessary to perform a one-quarter or one-eighth multiplier; however, in this example such a multiplier was included simply because of experience with previous experiments and/or calculations.

Turning now to Table 1 below, a list of multiplier values determined for a 39-layer structure and solved using a LSQCURVEFIT module within an optimization Toolbox™ from MATLAB is shown.

TABLE 1
“High”—Odd layer thicknesses (nm) = Multᵢ*550/(8*N) = d_{Hi}
“Low”—Even layer thicknesses (nm) = Multⱼ*550/(4*N) = d_{Lj}
(Multiplier List) Multiplier values

| (M1) | (M2) | (M3) | (M4) | (M5) | (M6) | (M7) |
|---|---|---|---|---|---|---|
| 0.0435 | 1.2139 | 0.1307 | 0.8384 | 2.2490 | 1.2396 | 1.7736 |
| (M8) | (M9) | (M10) | (M11) | (M12) | (M13) | (M14) |
| 1.1475 | 2.2261 | 0.0101 | 0.0122 | 1.0889 | 2.0830 | 1.1047 |
| (M15) | (M16) | (M17) | (M18) | (M19) | (M20) | (M21) |
| 2.2077 | 1.0959 | 0.0100 | 0.0101 | 2.0387 | 1.1277 | 2.0575 |
| (M22) | (M23) | (M24) | (M25) | (M26) | (M27) | (M28) |
| 1.4407 | 0.6883 | 1.8276 | 1.0380 | 0.5775 | 0.7862 | 0.6875 |
| (M29) | (M30) | (M31) | (M32) | (M33) | (M34) | (M35) |
| 0.7576 | 0.9844 | 0.3575 | 1.0429 | 0.5748 | 0.6599 | 0.9185 |
| (M36) | (M37) | (M38) | (M39) | | | |
| 0.7343 | 0.5068 | 0.876 | 0.3094 | | | |

Using the multipliers in Table 1 and incident angles of 0, 15, 30 and 45 degrees, calculations of the reflectance were performed in order to determine if a change in color, i.e. shift in band reflection, would occur at different angles. Desirably, the mean wavelength does not change with increasing angle and thus a truly omnidirectional color results. As shown in FIG. 6, with increasing incident angle, the calculations showed a continual “blue shift” of the mean reflected wavelength. However, this shift was less than 75 nanometers and thus a non-periodic layered structure exhibiting omnidirectional structural color is provided.

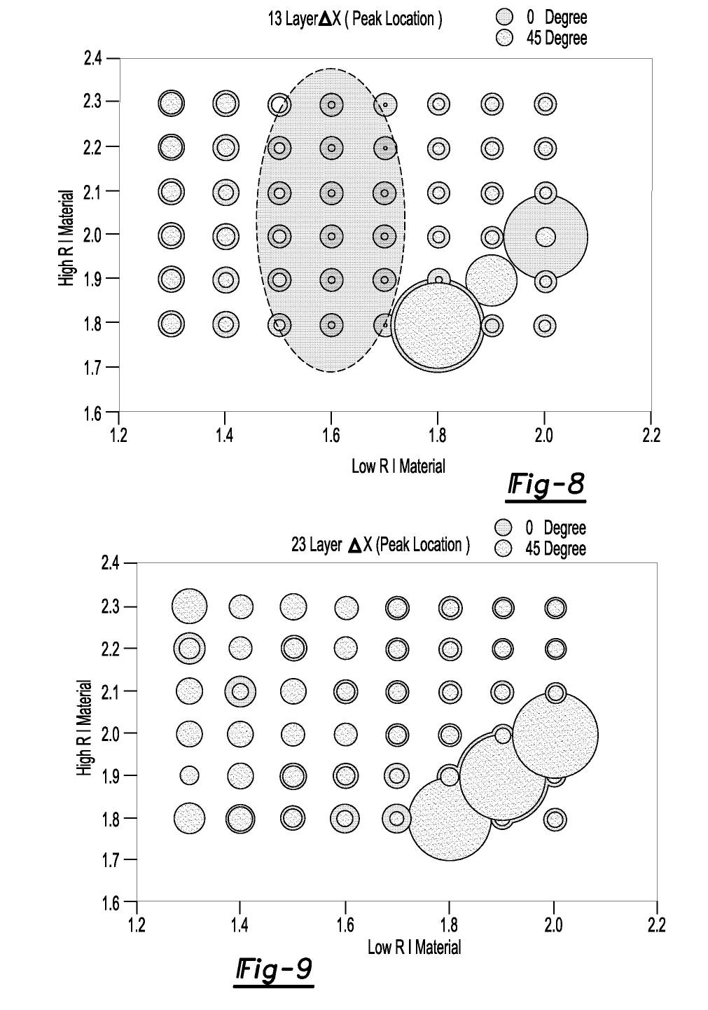

In order to develop a broad evaluation of possible materials that can be used for making an omnidirectional reflector, calculations were performed for materials having refractive indices ranging from 1.4 to 2.3 for the “high” index materials and 1.2 to 2.1 for the “low” index materials. Optimization parameters were defined as the absolute value of the difference in maximum wavelengths (ΔX) between an original prototype and an equivalent layer design, and the absolute value of the difference in maximum reflectance (ΔY) between the original prototype and the equivalent layer design. Examples of ΔX and ΔY are shown in FIG. 7 and it is appreciated that the X and Y coordinates for the maximum reflectance for the original prototype structure and the equivalent layer design were chosen to calculate ΔX and ΔY. In addition, in order to visually illustrate ΔX and ΔY as a function of refractive index pairs, plots such as FIGS. 8-11 were developed and discussed below.

FIG. 8 illustrates the difference in ΔX between an original 13-layer prototype and an equivalent 13-layer non-periodic design at 0 and 45 degree angles of incidence with the diameters of the shaded circles shown on the graph proportional to ΔX between the original prototype and the equivalent layer design. The larger the shaded circle, the greater the value of ΔX, and thus the greater the shift in the maximum wavelength between the original 13-layer prototype and the equivalent non-periodic layer design made from two materials having that lower refractive indices. In this manner, refractive index pairs can be easily identified in which there is a small difference in the maximum wavelengths between the original 13-layer prototype and the equivalent non-periodic layer design. Similarly, FIG. 9 illustrates ΔX between an original 23-layer prototype and an equivalent 23-layer non-periodic design at 0 and 45 degree angles of incidence.

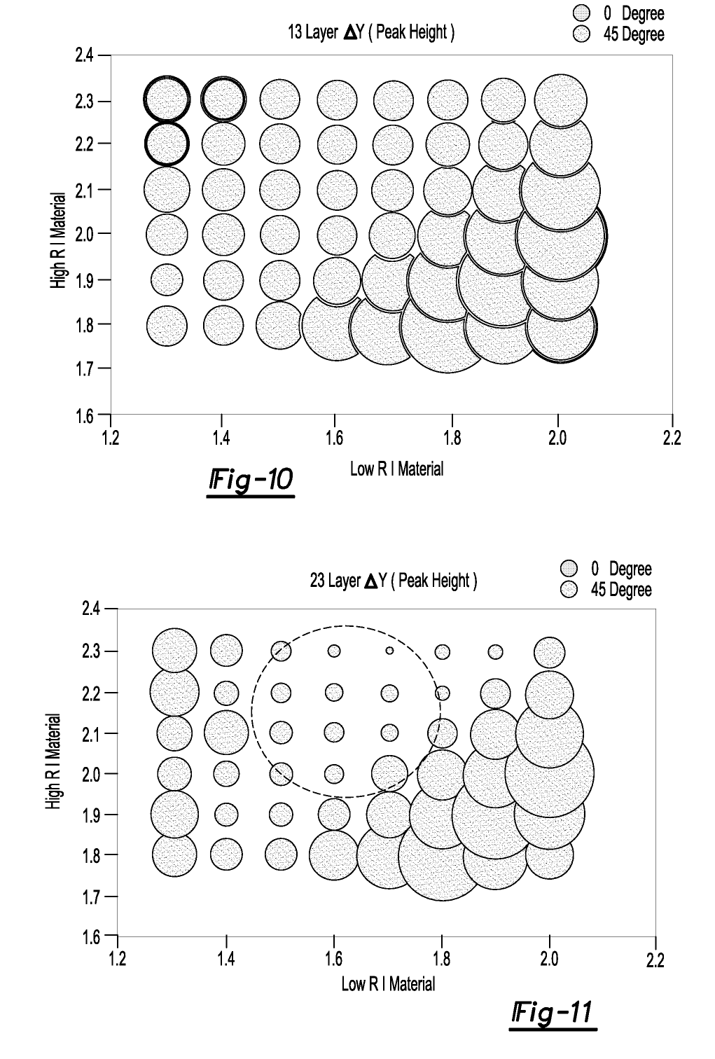

Turning now to FIGS. 10 and 11, ΔY between the 13-layer and 23-layer original prototypes and equivalent 13-layer and 23-layer non-periodic layer designs, respectively, are shown as a function of refractive index pairs for 0 and 45 degree incidence angles. As with FIGS. 8 and 9, review of FIGS. 10 and 11 allow easy identification of refractive index pairs in which there is a small difference in ΔX and ΔY between original multi-layer prototypes and equivalent non-periodic multi-layer designs. For example, review of FIGS. 8-11 illustrates that a first material with a refractive index in the range of 1.5 to 1.7 and a second material with a refractive index in the range of 2.0 to 2.3 could be suitable for making a non-periodic multilayer stack that exhibits omnidirectional structural color with a color/reflectance band centered about 575 nanometers.

It is appreciated that altering or selecting a different target reflection band (e.g. a different color) can change the actual trends shown in FIGS. 8-11. However, trends will still exist and thus identification of suitable refractive index pairs is provided.

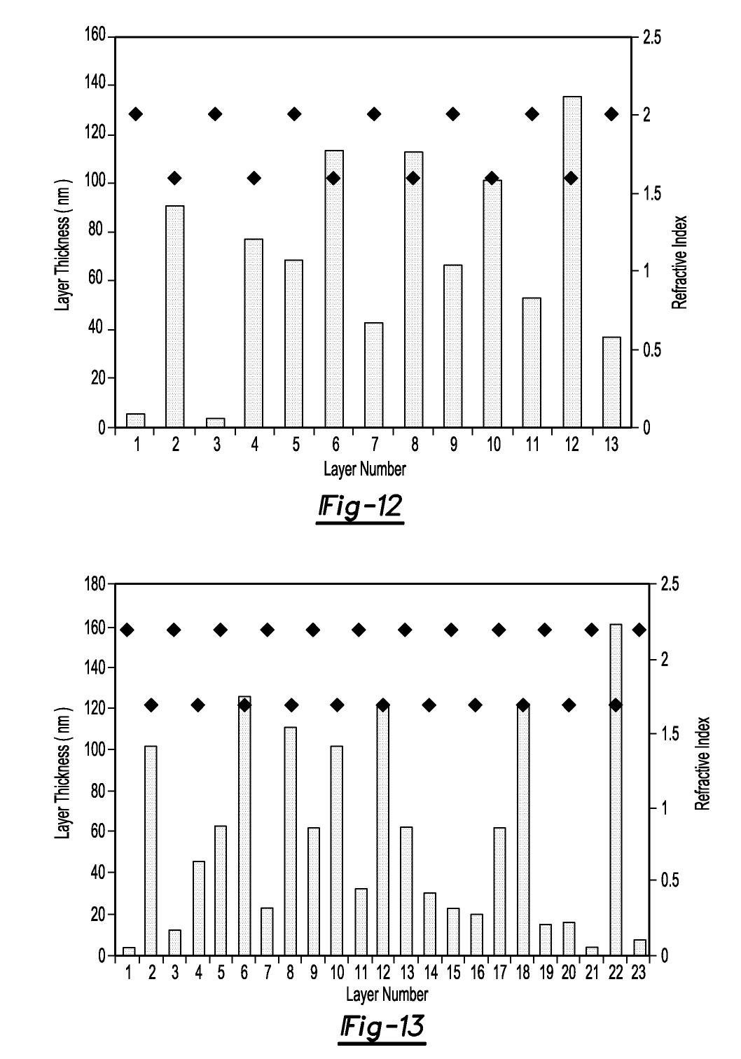

Illustrating actual design thicknesses for a non-periodic omnidirectional structural color, FIG. 12 shows a schematic thickness plot for a 13-layer non-periodic multilayer made from a first material having a refractive index of 2.0 and a second material having a refractive index of 1.6 are shown in FIG. 12. The thicknesses of the various layers are shown by the elongated rectangles which correspond to the left y-axis and the refractive index of each layer is shown by the solid diagonals which correspond to the right y-axis. Similarly, the layer thicknesses for a 23-layer non-periodic omnidirectional structural color made using a first material with a refractive index of 2.2 and a second material with a refractive index of 1.7 are shown in FIG. 13.

In this manner, an omnidirectional structural color can be designed and manufactured for most any given desired wavelength using a greater range of materials than previously available. Such materials include metals, semiconductors, ceramics, polymers, and combinations thereof. It is appreciated that the opportunity to use a greater range of materials further affords for a greater range of manufacturing techniques to make desired multilayer stacks/structures.

In addition to the above, the multilayer stack can have at least one third index of refraction material layer C1, at least one fourth index of refraction material D1, and/or at least one fifth index of refraction material layer E1. The at least one A1, B1, C1, D1 and/or E1 can each have the various material layers made from any material known to those skilled in the art having suitable refractive indices and known now, or in the future, to be used or can be suitably used to produce multilayer structures using processes, techniques, equipment, and the like such as sol gel techniques, vacuum deposition techniques, layer-by-layer techniques, etc.

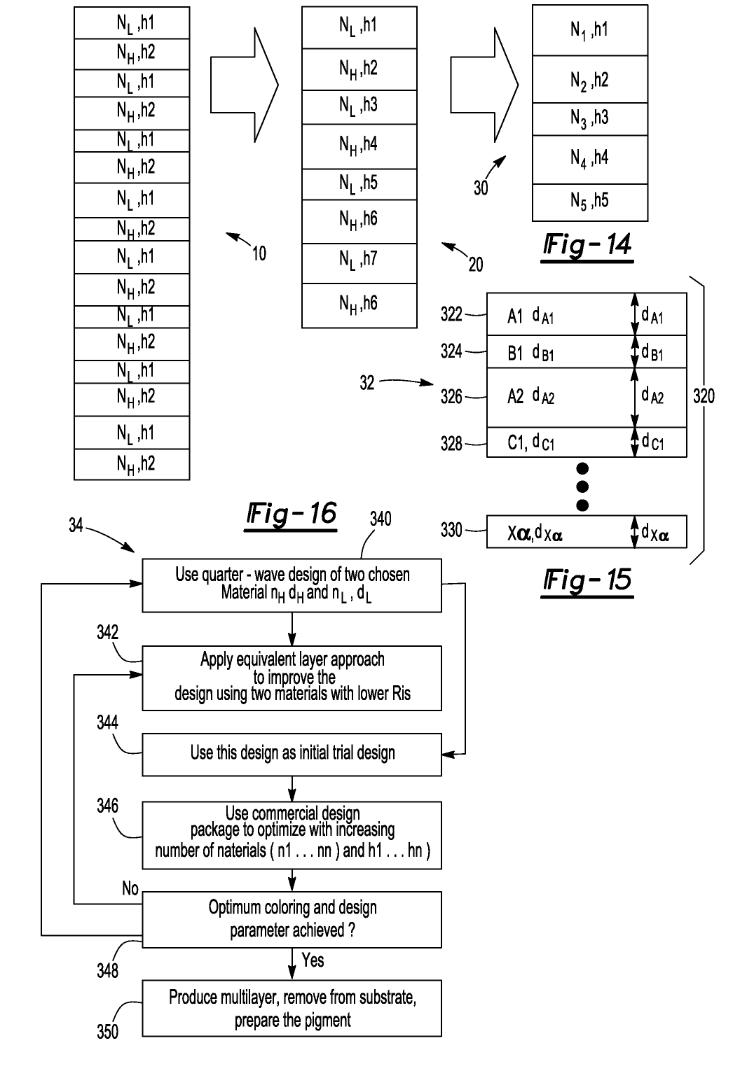

Turning now to FIG. 14, a schematic illustration is provided where an omnidirectional structural color (OSC) made from a multilayer stack 10 includes a plurality of alternating layers of low index of refraction material N_{L} and high index of refraction material N_{H}. Each of the low and high index of refraction materials has a corresponding thickness of h₁ and h₂, respectively. In the alternative, an OSC having a multilayer stack 20 is disclosed herein in which the low index of refraction material N_{L} and the high index of refraction material N_{H} do not necessarily have the same thicknesses throughout the multilayer stack as indicated by the different thicknesses h₁, h₂, h₃, . . . h₆. With even further improvements disclosed herein, an OSC having a multilayer stack structure 30 includes a first index of refraction material N₁, a second index of refraction material N₂, a third index of refraction material N₃, a fourth index of refraction material N₄, and a fifth index of refraction material N₅. In addition, each of the material layers can have a different thickness as schematically illustrated by the different thicknesses h₁, h₂, h₃, h₄, and h₅.

FIG. 15 provides an alternative illustration of such a multilayer stack 30 as shown generally at reference numeral 32. The multilayer stack 32 has a plurality of layers 320 which for illustrative purposes only are shown as a first index of refraction material layer A1 shown at reference numeral 322, a second index of refraction material layer B1 shown at 324, an additional layer of the first index of refraction material A2 shown at 326, and a third index of refraction material layer C1 shown at 328. As also shown in FIG. 15, additional layers made from the first, second, or third index of refraction material can be included, as can layers made from different materials and illustratively shown as Xα at 330. Each of the layers 322-330 can have a unique thickness d_{A1}, d_{B1}, d_{A2}, d_{C1}, . . . d_{Xα}. In this manner, a multilayer stack having at least three layers, made from at least two different materials, and in some instances made from at least here different materials, and having a non-periodic layered structure is provided and used as an omnidirectional reflector.

A process for making such an OSC, also referred to herein as an omnidirectional reflector, is shown generally at reference numeral 34 in FIG. 16. The process 34 can include using a quarter wave design of two materials for omnidirectional structural color having a desired omnidirectional reflection band at step 340. Thereafter, an equivalent layer approach can be applied to the quarter wave design developed at step 342 in order to improve the quarter wave design and afford for the use of alternate materials, for example materials having lower indices of refraction. The design provided or obtained at step 342 can be used at step 344 to provide an initial trial or, in the alternative, the quarter wave design developed at step 340 can be used for an initial trial at step 344. At step 346 additional optimization can be provided such that the number of materials is increased from two to at least three.

At step 348, the design provided at step 346 is determined as to whether or not optimum coloring, reflectance, design parameter, and the like have been achieved. In the event that a desired property or parameter has not been achieved, the process can start over at step 340 or start over at step 342. In the event that optimum coloring, design parameter, etc. has been achieved, the process can proceed to step 350 in which a multilayer stack is provided, removed from a substrate, and used to prepare a pigment. In the alternative, the multilayer stack can be applied as a thin film to a substrate and left there to provide desired coloring.

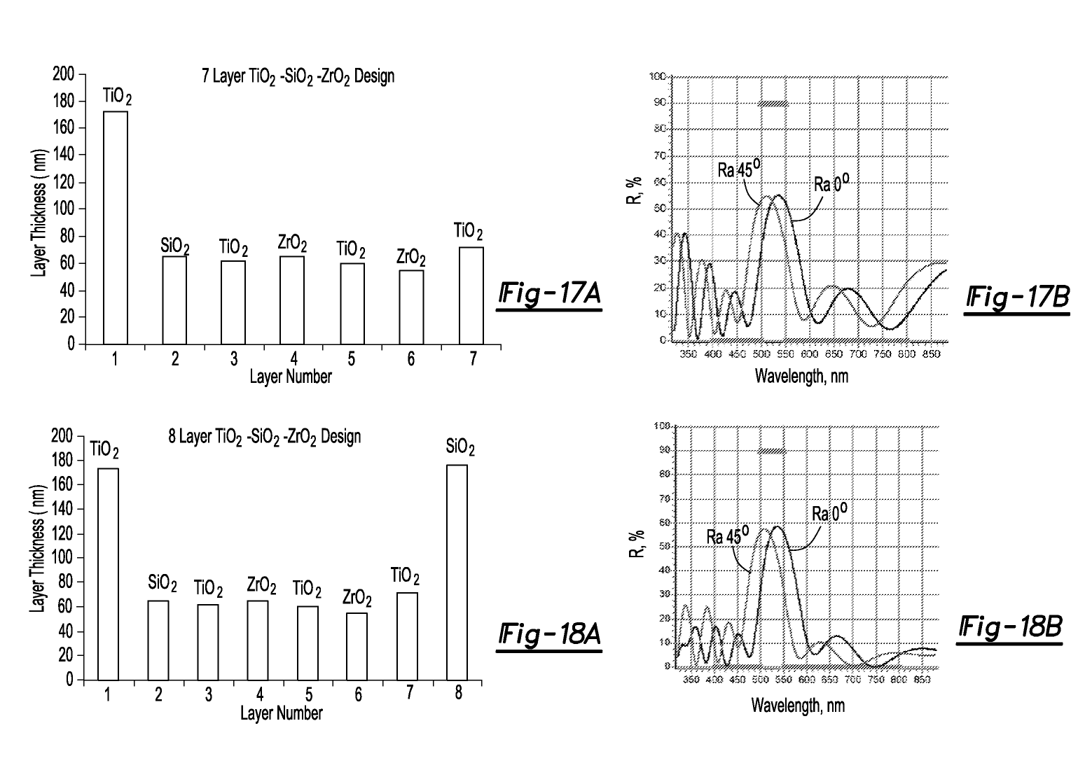

Using such a process as shown in FIG. 16, FIGS. 17-26 provide a series of results for various multilayer stack designs. For example, FIG. 17A provides a graphical representation of layer thickness and material for a seven-layer design using titanium oxide, silicon oxide, and zirconium oxide. As shown by the thicknesses of the various layers, a non-periodic layered structure is provided by the process 34. In addition, FIG. 17B provides a calculated percent reflectance as a function of electromagnetic radiation wavelength for the structure represented in FIG. 17A. As shown in FIG. 17B, the structure of FIG. 17A reflects at least 50% of a narrow band of electromagnetic radiation less than 100 nanometers and having a wavelength of approximately 525 nanometers when viewed from angles between 0 to 45 degrees. Stated differently, the structure of FIG. 17A has an omnidirectional band of less than 100 nanometers when exposed to a broad band of electromagnetic radiation and the broadband radiation is incident on the surface of such a structure at angles between 0 and 45 degrees.

FIGS. 18A and 18B provide a similar graphical representation of an eight-layer design and omnidirectional reflection band produced thereby. The eight-layer design has an initial layer of titanium oxide; alternating layers of silicon oxide, titanium oxide, and zirconium oxide; followed by a final layer of silicon oxide. FIG. 18B illustrates that such a structure has a narrow omnidirectional reflection band that reflects at least 50% of a narrow band of radiation at approximately 525 nanometers. In addition, the eight-layer design exhibits reduced side bands when compared to the design of FIG. 17.

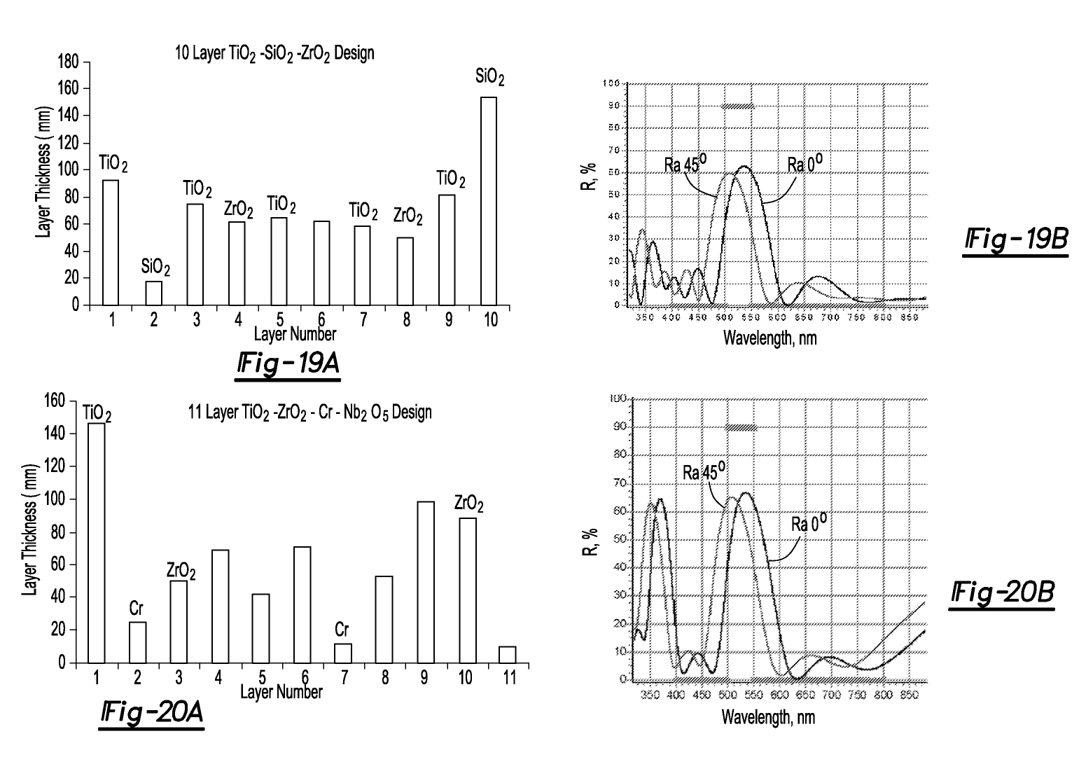

FIG. 19 shows the results for a ten-layer design made from titanium oxide, silicon oxide, and zirconium oxide.

Looking now to FIG. 20, an eleven-layer design made from titanium oxide, zirconium oxide, chromium, and niobium oxide is shown. FIG. 20A shows the various layer thicknesses for the various layers, and FIG. 20B shows the reflectance as a function of electromagnetic radiation wavelength. As can be seen in FIG. 20B, the structure of FIG. 20A provides a first omnidirectional reflection band that reflects at least 50% of a narrow band of radiation at approximately 525 nanometers when viewed from angles between 0 to 45 degrees. In addition, a second omnidirectional reflection band in the infrared region at approximately 360 nanometers is provided by the design illustrated in FIG. 20A.

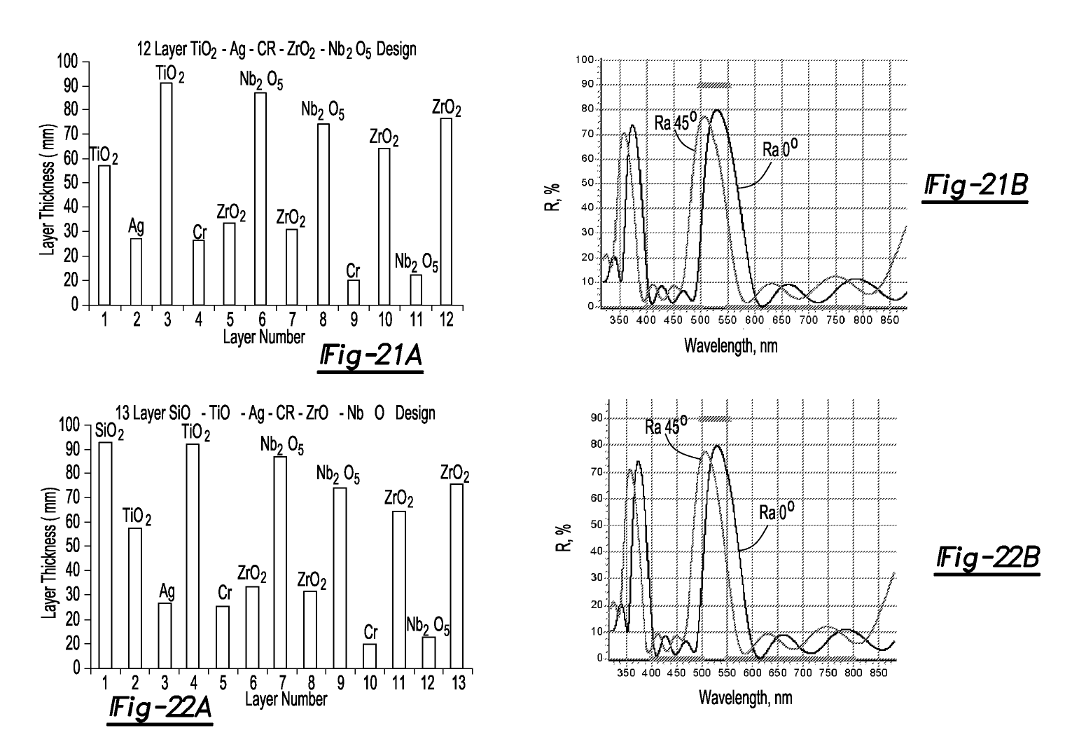

FIG. 21 provides a similar graphical representation and reflectance as a function of wavelength for a twelve-layer design using titanium oxide, silver, chromium, zirconium oxide, and niobium oxide materials. FIG. 22 shows a thirteen-layer design for the same materials used in FIG. 21 except for the addition of silicon oxide.

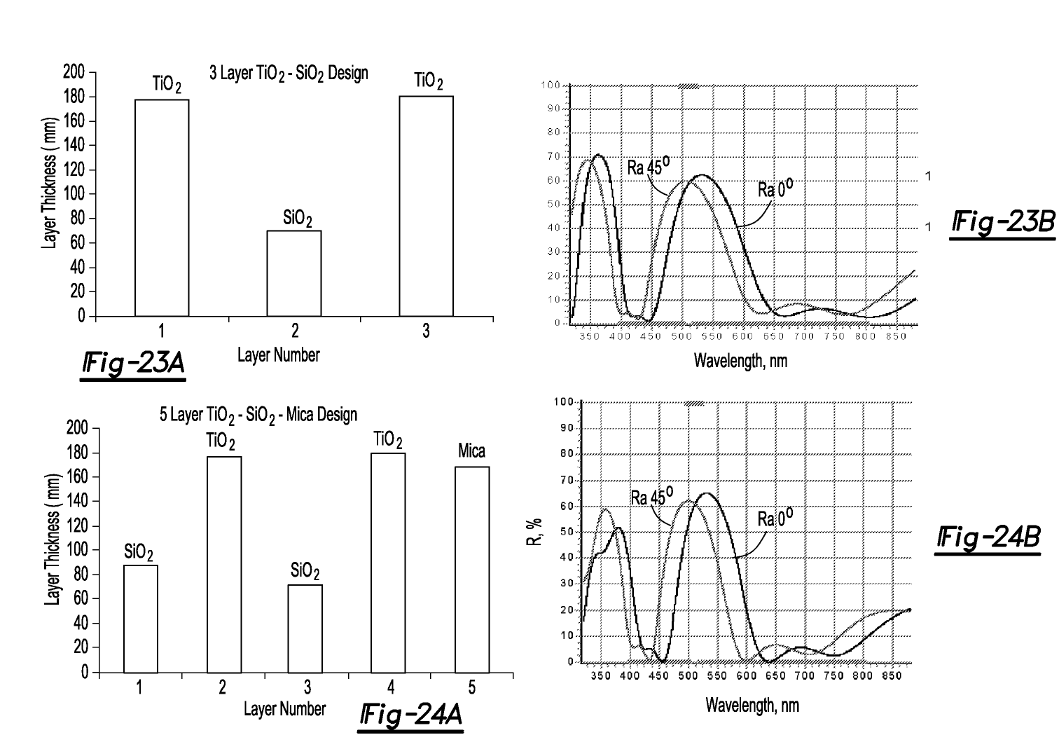

In an effort to further reduce the number of layers for a multilayer stack, process 34 was used to design the three-layer stack shown in FIG. 23 and the five-layer design shown in FIG. 24. The three-layer design containing titanium oxide and silicon oxide materials exhibited a calculated reflectance spectrum as shown in FIG. 23B and the five-layer design in which titanium oxide, silicon oxide, and mica were used in the process 34 exhibited a reflectance spectrum shown in FIG. 24B.

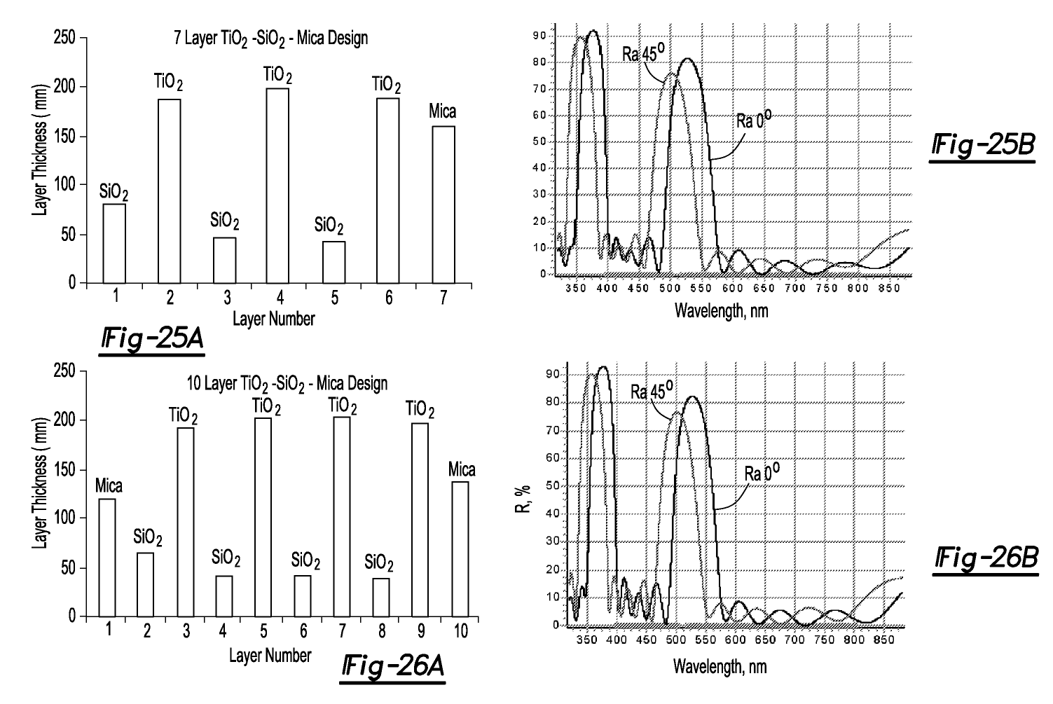

A seven-layer design and a ten-layer design using the same materials, that is titanium oxide, silicon oxide, and mica, are shown in FIGS. 25 and 26, respectively. It is appreciated from the reflectance spectrum for the three-layer, five-layer, seven-layer, and ten-layer designs illustrated in FIGS. 23-26 that such multilayer structures exhibit omnidirectional reflection bands within the visible light spectrum, for example approximately 525 nanometers, in addition to an infrared omnidirectional reflection band at approximately 350 nanometers.

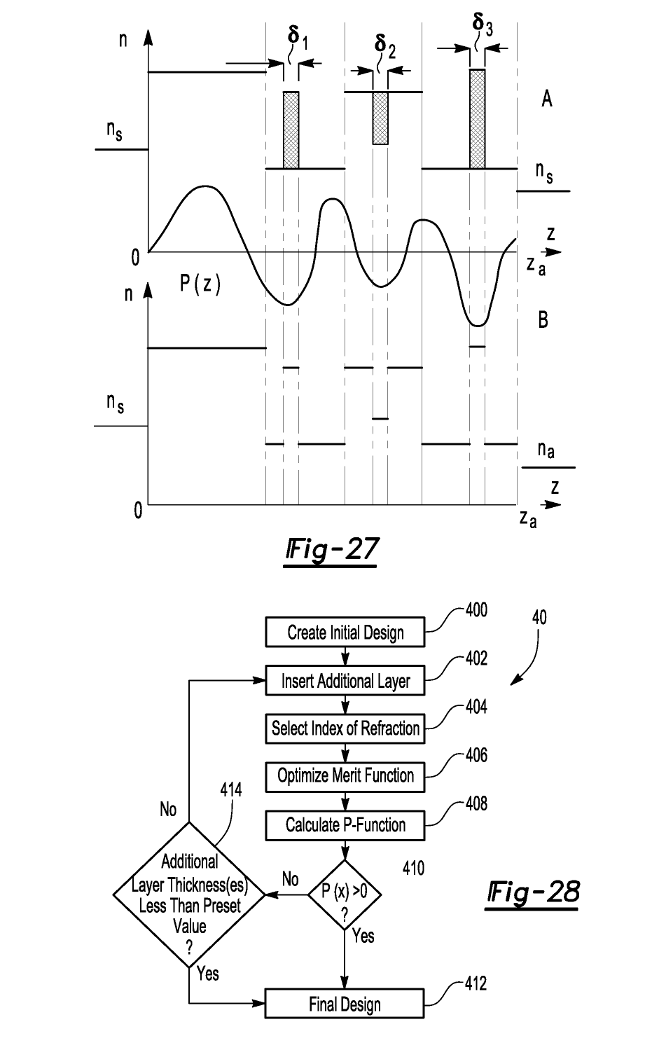

In one embodiment to further reduce the number of layers of a multilayer stack, a process for designing and manufacturing an OSC multilayer stack is provided. The process can include “needle optimization” to design and produce OSC multilayer stacks that have non-periodic layered structures and can use one or more different materials. For the purposes of the present invention, the term “needle optimization” refers to the mathematical optimization of an OSC multilayer stack via optimization of a merit function. In particular, the OSC multilayer stack is viewed as an interference structure having properties related to interference effects among electromagnetic waves reflected from boundaries between the multiple layers. The interference effects of the multilayer stack are determined by phases and amplitudes of reflected electromagnetic waves and the smaller the merit function, the closer the correspondence between a target and actual design characteristics. In addition, at least one new layer is inserted into an existing OSC multilayer structure which essentially changes the refractive-index profile of the structure as illustrated in FIG. 27.

The merit function considers a single layer, also known as a needle, variation of the refractive index profile inserted at some point z and having a thickness δ and a refractive index of n. The variation of the merit function can be represented as a series with respect to the thickness of a new layer:

δF=P₁(z,n)δ+P₂(z,n)δ+ (5)

with the coefficients of the series depending on the position of the new layer inside the OSC multilayer stack as well as on the refractive index of the new layer.

It is appreciated that the refractive index can be taken from a table of values (e.g. see Table 3) that correspond to desired materials to be used to manufacture the OSC multilayer stack and as such the new layer cannot assume an arbitrary value. In addition, denoting n₁, n₂, . . . , nⱼ as the refractive indices of the materials that can be used to produce or manufacture the OSC multilayer stack, the P-function:

$$P ( z ) = {min}_{1 < j < J} {P}_{j} ( z , {n}_{j} ) \qquad ( 6 )$$

can be plotted as shown in FIG. 27 with one or more locations for inserting an additional layer identified by the most negative values of the P-function. For example, places marked on the z axis in FIG. 27 where additional layers having thicknesses δ₁, δ₂, and δ₃ are shown. In some instances, a new layer can be the same material as, for example, a material used to produce the initial design, or in the alternative a new layer can be a different material. For example, and for the case of an OSC multilayer stack having more than two materials, refractive indices of new inserted layers can be chosen as those refractive index values that provide a minimum in Equation 6 at the corresponding z points as illustrated in FIG. 27.

Typically, the needle optimization technique includes a sequence of insertions of new layers in the initial design structure followed by a corresponding sequence of optimizations of the thicknesses of the layers. For example, FIG. 28 illustrates such a process at reference numeral 40 with an initial design created or input into the process at step 400, followed by insertion of an additional layer 402. It is appreciated that the additional layer can be inserted as taught by FIG. 27 in which a location within a multilayer structure for insertion of the new layer is determined by locations where the P function has minimum values. In addition, the material that will be used for the new layer can be selected from the index of refraction that provides the lowest values for the P-function.

After insertion of at least one additional layer at step 402, the index of refraction can be selected at step 404 along with optimization of the merit function at step 406. In the alternative, the index of refraction can be selected before insertion of the at least one additional layer. Thereafter, the P-function can be calculated at step 408 and if the P-function is determined to be greater than zero at step 410, a final design is deemed to be determined at step 412. If the P-function is not greater than zero at step 410, whether or not additional layer thicknesses are less than a preset value can be determined at step 414.

In the instance that additional layer thicknesses are not less than a preset value, i.e. the thicknesses of the additionally inserted layer(s) can be produced using a desired manufacturing technique, then one or more additional layers can be inserted at step 402 and the process can proceed as described above. In the alternative, if additional layer thicknesses of inserted layers are less than a preset value, i.e. the thicknesses of the additionally inserted layer(s) cannot be produced using a desired manufacturing technique, then the process can proceed to the final design determination at step 412. As such, the process determines an OSC multilayer stack having desired optical properties.

Principal features of the needle optimization technique can be:
1. The choice of a starting design is not critical.
2. The overall optical thickness can be a critical parameter for the choice of a starting design and a thicker optical thickness, i.e. starting design, results in a final design with more layers and a lower merit function value.
3. A single layer can be inserted at a given time or, in the alternative, several layers can be inserted at a given time.
4. Dispersive materials can be used within the multilayer stack or as a given substrate.
5. Non-absorbing, absorbing, and dispersive materials can be used in the technique.
6. Desired optical properties or targets can be used within the technique. As such, a desired percent reflectance, chroma, hue shift, and the like can be a desired target incorporated within the P-function.

In order to provide additional teaching of the process and yet not limit the scope of the invention in any way, examples of optimized OSC multilayer stacks are provided below.

### Example 1

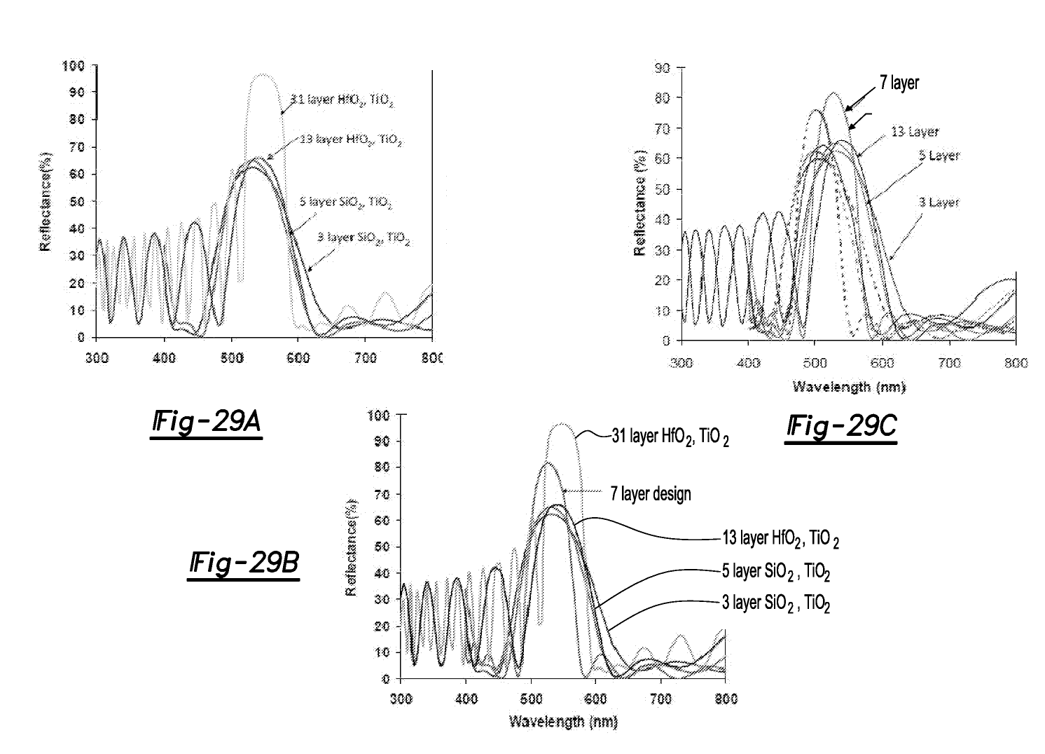

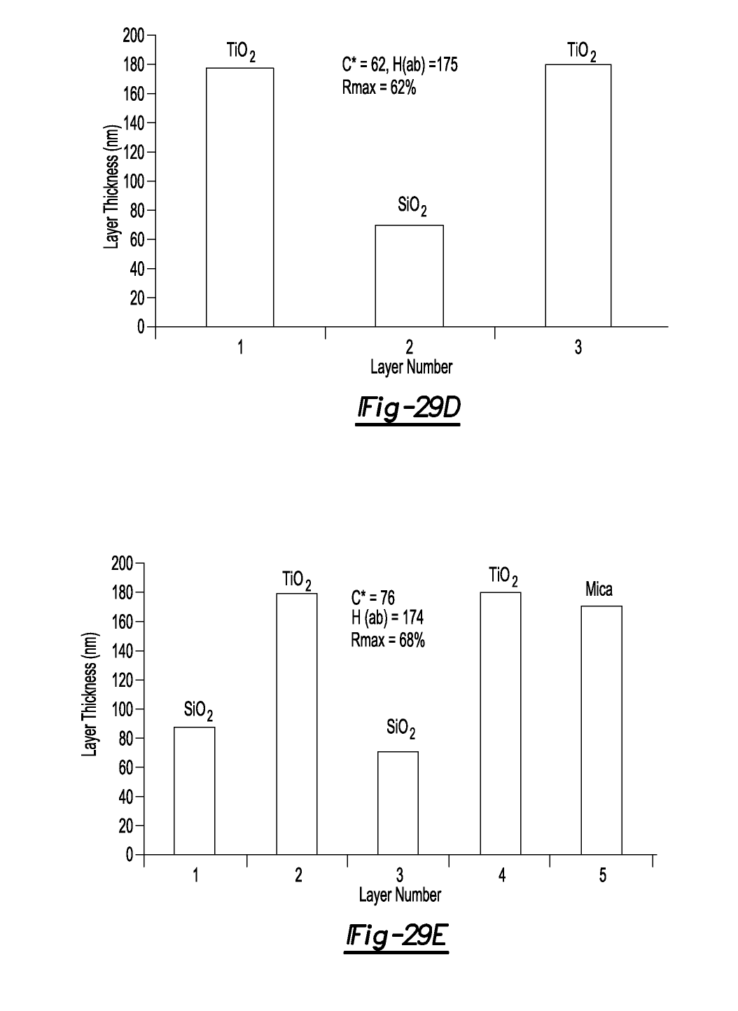

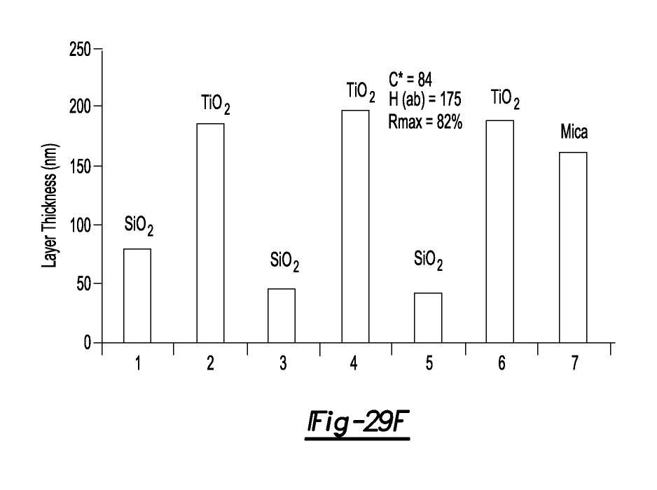

Referring now to FIGS. 29A-F, the inventive process disclosed herein was used to design optimized 3-layer, 5-layer, and 7-layer OSC multilayer stacks. The 3-layer stack had two layers of TiO₂ and one layer of SiO₂ (FIG. 29D), the 5-layer stack had alternating layers of SiO₂ and TiO₂ with the addition of a final mica layer (FIG. 29E), and the 7-layer stack had alternating layers of SiO₂ and TiO₂ with a final layer of mica (FIG. 29F). FIGS. 29D-F provides the thicknesses of each layer for the 3-layer, 5-layer, and 7-layer designs, respectively, that were obtained through the process illustrated in FIG. 28. In addition, FIG. 29A provides a comparison of reflectance versus wavelength between 3-layer and 5-layer optimized OSC multilayer stacks and equivalent 13-layer and 31-layer HfO₂—TiO₂ OSC multilayer stacks. It is appreciated that for the purposes of the present invention, the term “equivalent” OSC multilayer stacks refers to OSC multilayer stacks having a quarter wave periodic design that reflect generally the same narrow band of electromagnetic radiation as the optimized OSC multilayer stacks.

As shown in FIG. 29A, the 3-layer and 5-layer SiO₂—TiO₂ optimized OSC multilayer stacks provide essentially the same percent of reflectance as the 13-layer equivalent HfO₂—TiO₂ OSC multilayer stack. In addition, the 3-layer and 5-layer optimized SiO₂—TiO₂ OSC multilayer stacks have reduced side bands compared to the 13-layer and 31-layer equivalent HfO₂—TiO₂ OSC multilayer stacks.

FIG. 29B includes the reflectance versus wavelength for the 7-layer SiO₂—TiO₂ optimized OSC multilayer stack and FIG. 29C illustrates the omnidirectional behavior of the 3-layer, 5-layer, and 7-layer optimized OSC multilayer stacks by illustrating the shift in reflectance peaks, i.e. lack thereof, when viewed from 0 and 45 degrees.

Regarding the chroma and hue shift for the 3-layer, 5-layer, and 7-layer optimized OSC multilayer stacks, FIGS. 29D-F provide chroma and hue shift results. As shown in these drawings, the minimum chroma was exhibited for the 3-layer optimized OSC multilayer stack and the highest was exhibited for the 7-layer optimized OSC multilayer stack. In addition, the hue shift was the lowest for the 3-layer optimized OSC multilayer stack and approximately equivalent for the 5-layer and 8-layer optimized stacks.

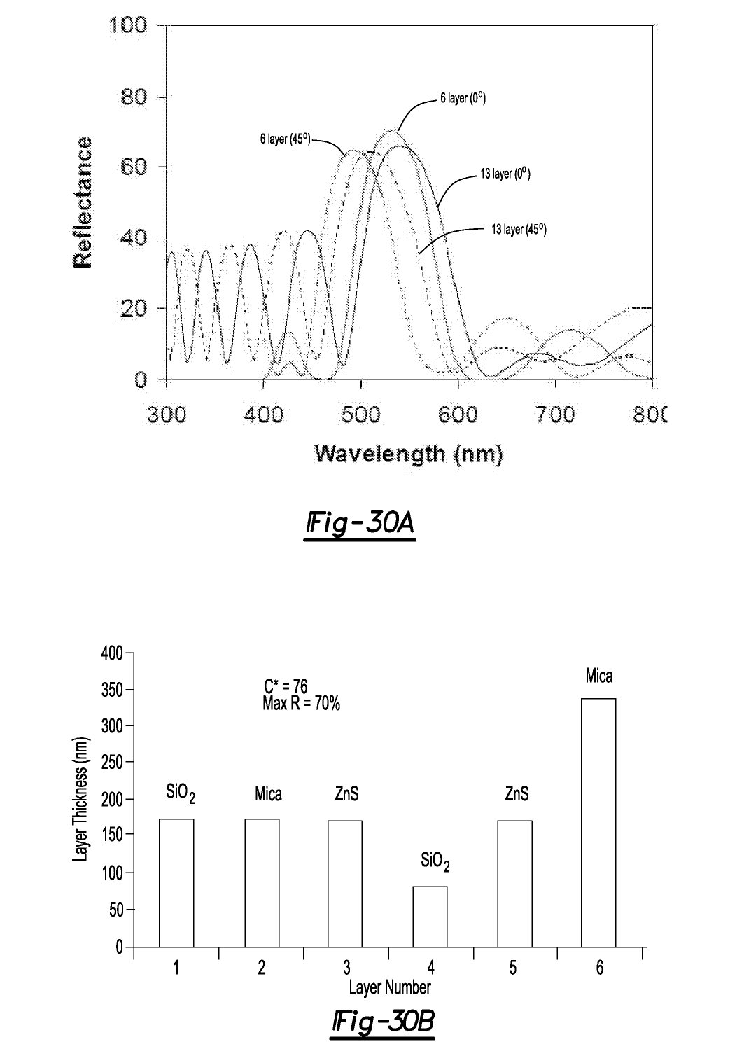

Referring now to FIG. 30A, the results for an optimized 6-layer OSC multilayer stack in which ZnS was used to replace TiO₂ are shown in comparison to the equivalent 13-layer design shown in FIG. 29. The thicknesses of the various layers are in FIG. 30B.

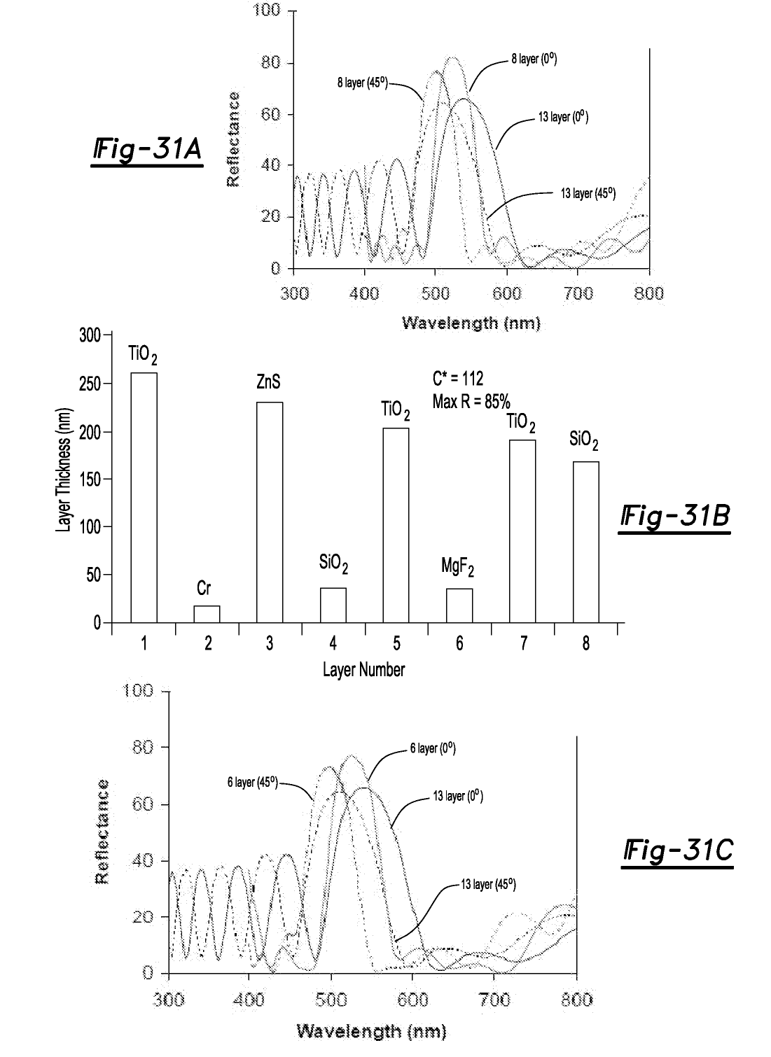

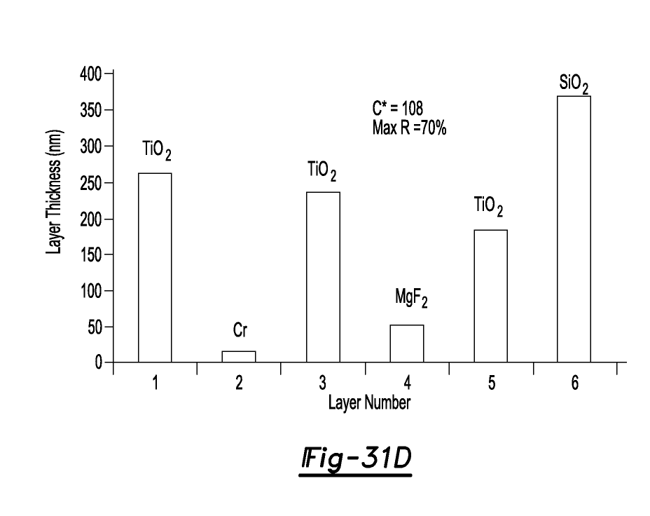

Referring now to FIGS. 31A-D, MgF₂ was used to replace mica and TiO₂ and chromium (Cr) were incorporated to produce 8-layer (FIGS. 31A-B) and a 6-layer (FIGS. 31C-D) optimized OSC multilayer stacks. As shown in FIG. 31A, reflectance versus wavelength for the optimized 8-layer OSC multilayer stack and the equivalent 13-layer stack shown in FIG. 29 are shown for viewing angles of 0 and 45 degrees. In addition, FIG. 31C illustrates the reflectance versus wavelength for the 6-layer optimized TiO₂—Cr—MgF₂—SiO₂ OSC multilayer stack and the 13-layer equivalent design shown in FIG. 29 for viewing angles of 0 and 45 degrees. As illustrated by these figures, both the 8-layer and the 6-layer optimized stacks provide increased reflectance and equivalent omnidirectional behavior compared to the equivalent 13-layer design. In addition, the chroma for the optimized 8-layer design was 112 while for the optimized 6-layer design the chroma was 108. It is appreciated that depending upon desired optical properties, cost considerations, and the like that a reduced chroma and increased hue shift can be used as part of a compromise to obtain a suitable optimized OSC multilayer stack.

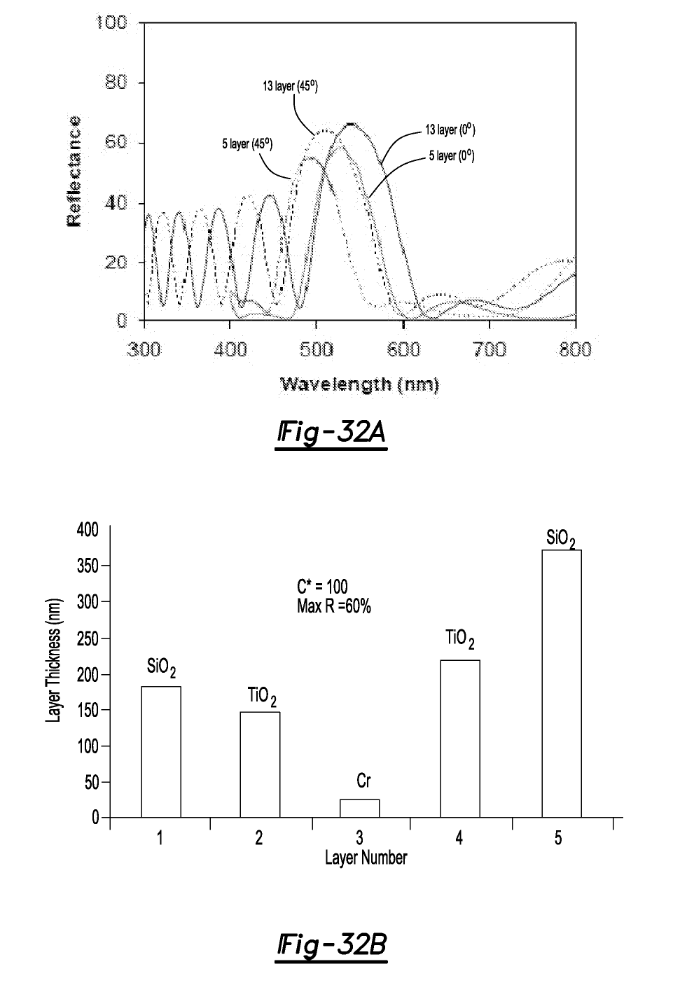

FIG. 32A illustrates the reflectance versus wavelength at viewing angles of 0 and 45 degrees for an optimized 5-layer SiO₂—TiO₂—Cr OSC multilayer stack, along with a comparison to the 13-layer equivalent design shown in FIG. 29. The thicknesses of the SiO₂, TiO₂, and Cr layers are shown in FIG. 32B, along with the chroma (C*) and maximum reflectance (Max R).

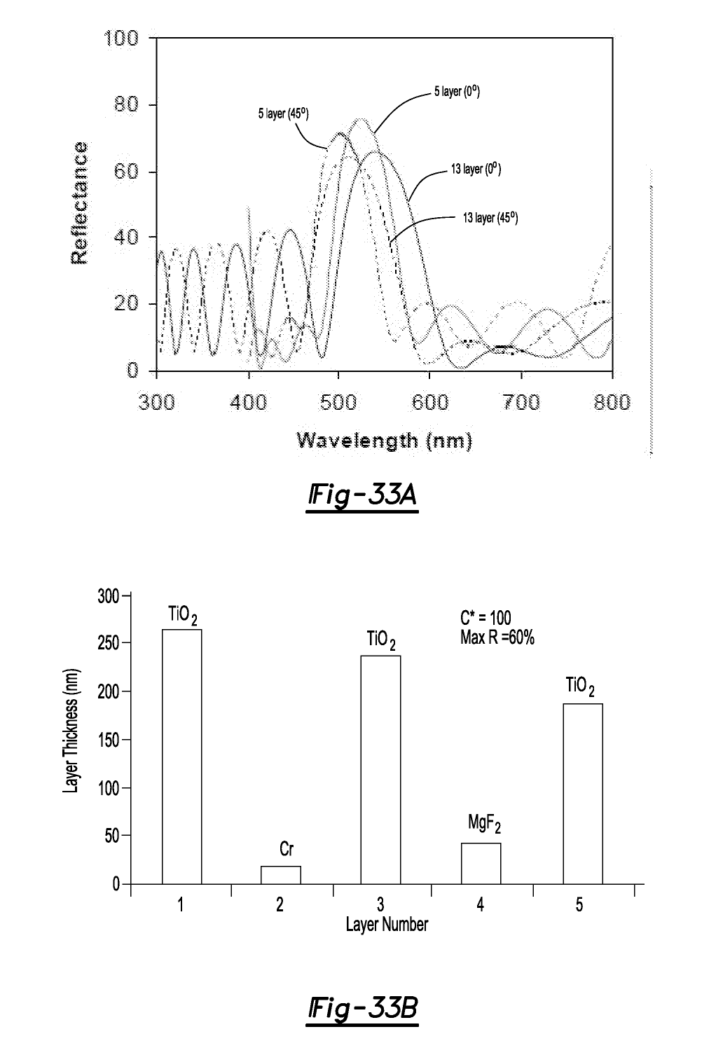

The reflectance versus wavelength for a 5-layer TiO₂—Cr—MgF₂ optimized OSC multilayer stack for viewing angles of 0 and 45 degrees are shown in FIG. 33A along with a comparison to the 13-layer equivalent stack shown in FIG. 29. The thicknesses of the TiO₂—Cr—MgF₂ layers are shown in FIG. 33B. As shown in these figures, increased reflectance compared to the 13-layer design with generally equivalent omnidirectional behavior was obtained.

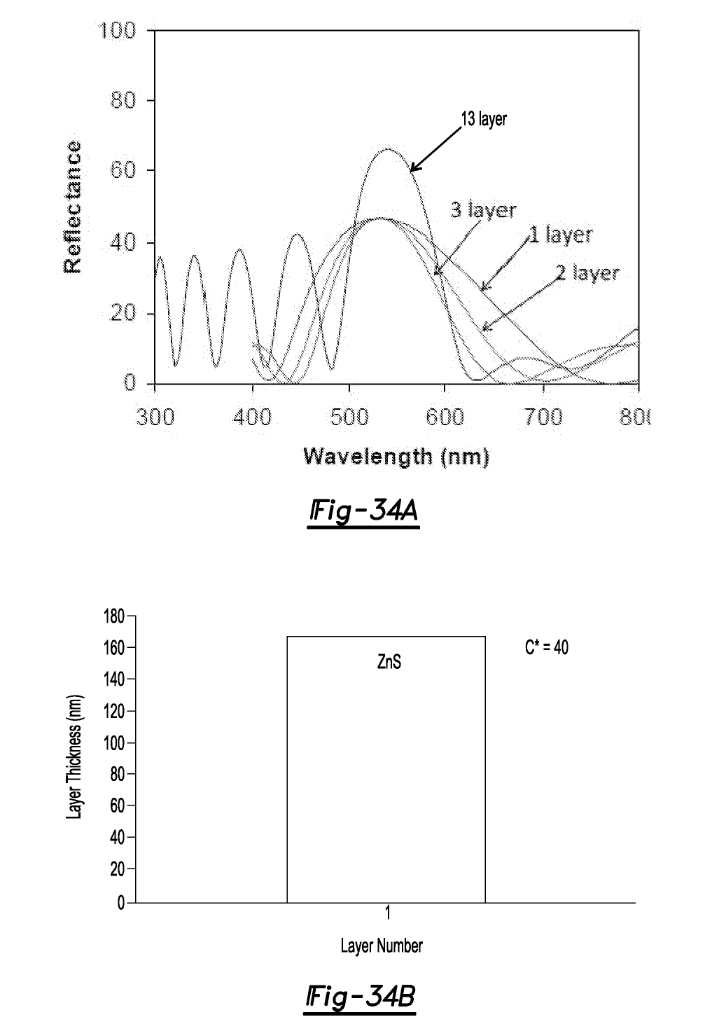

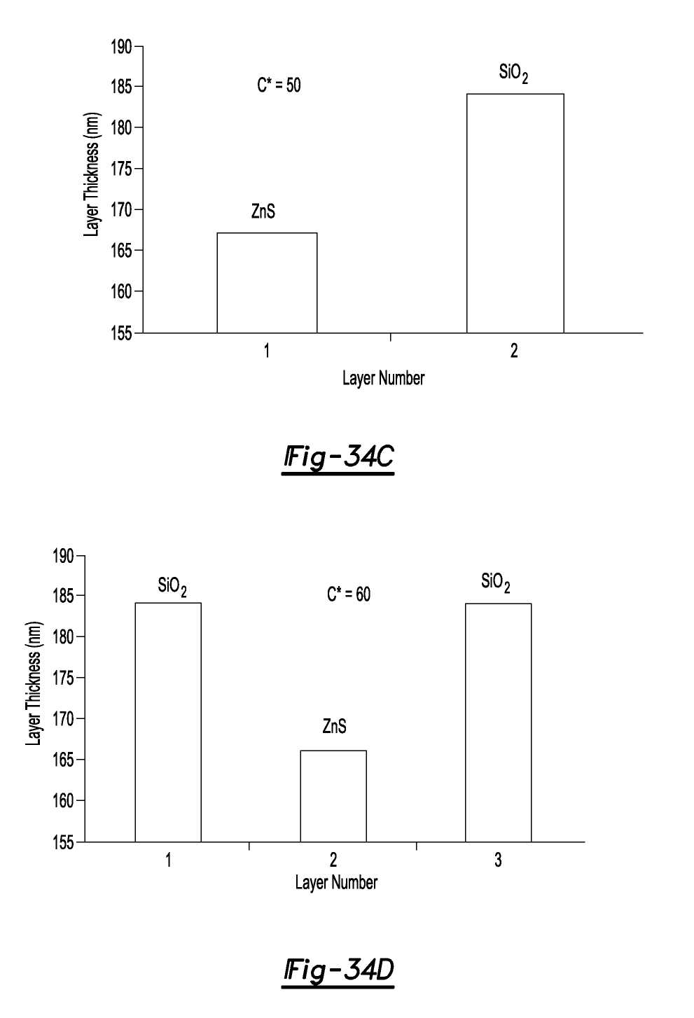

Turning now to FIG. 34A, reflectance versus wavelength results for optimized 1-layer, 2-layer, and 3-layer OSC multilayer stacks are shown along with the 13-layer equivalent design shown in FIG. 29 with the thicknesses of the layers shown in FIGS. 34B-D. As shown in these figures, even a single optimized layer can provide up to 40% reflectance and a chroma of 40 (FIG. 34B).

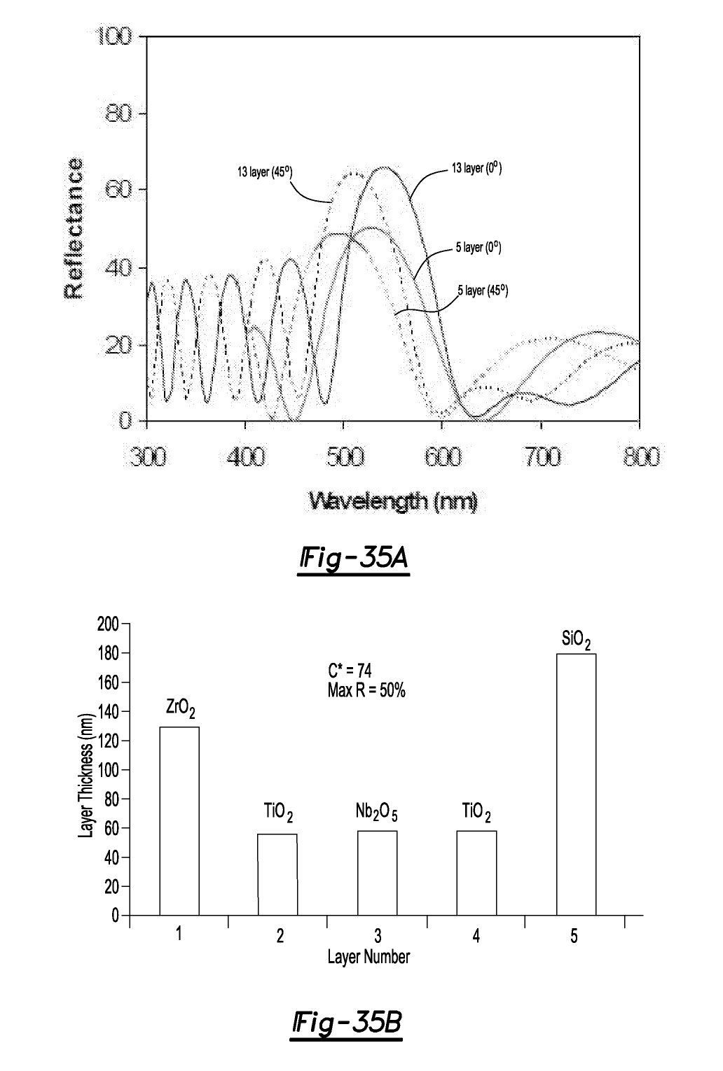

FIG. 35A illustrates reflectance versus wavelength for an optimized 5-layer ZrO₂—TiO₂—Nb₂O₅ OSC multilayer stack and the 13-layer equivalent design shown in FIG. 29 when viewed from 0 and 45 degrees with the thicknesses of the layers shown in FIG. 35B.

Given the above examples, it is appreciated that a wide variety of OSC multilayer stacks can be designed and optimized using the process disclosed herein. In addition, depending upon material cost considerations, availability, and the like, the process provides a powerful tool to design cost effective OSC multilayer stacks that can be used as coatings, pigments, and the like. It is also appreciated that the manufacture of such OSC multilayer stacks can be executed by providing the given material for a particular design and producing a multilayer structure having thicknesses as determined by the design. Thereafter, the multilayer structure can be used as a coating or, in the alternative, removed from a sacrificial substrate and ground to a desired size such that it can be used as a pigment, e.g. a paint pigment. Table 2 below provides a summary of the needle optimization reduced layer designs with the peak reflectance at approximately 550 nanometers being equivalent to a color of green.

TABLE 2

| Number of | | Reflectance | |
|---|---|---|---|
| Layers | Material | (%) | Chroma |
| 1 | ZnS | 50 | 40 |
| 2 | ZnS, SiO₂ | 50 | 50 |
| 3 | ZnS, SiO₂ | 50 | 60 |
| 3 | TiO₂, SiO₂ | 62 | 62 |
| 5 | TiO₂, SiO₂, Mica | 76 | 68 |
| 5 | TiO₂, SiO₂, Cr | 60 | 100 |
| 5 | ZrO₂, Nb₂O₅, TiO₂, SiO₂ | 50 | 78 |
| 6 | SiO₂, MgF₂, TiO₂, Cr | 70 | 108 |
| 6 | SiO₂, Mica, ZnS | 70 | 108 |
| 8 | SiO₂, ZnS, MgF₂, TiO₂, Cr | 85 | 112 |
| 8 | SiO₂, TiO₂, Mica | 82 | 84 |

It is appreciated from the above disclosure that specific embodiments and examples have been provided for illustrative purposes only. As such, the embodiments and the examples are not meant to limit the scope of the invention in any way and thus the specification should be interpreted broadly. It is the claims, and all equivalents, that define the scope of the invention.

In this manner, an omnidirectional structural color can be designed and manufactured for most any given desired wavelength using a greater range of materials than previously available. It is appreciated that multilayer designs using more than two materials as disclosed above are completely novel. Such materials include metals, semiconductors, ceramics, polymers, and combinations thereof. For example and for illustrative purposes only, Table 3 below provides a list of illustrative materials for production of multilayer stacks. It is appreciated that the opportunity to use a greater range of materials further affords for a greater range of manufacturing techniques to make desired multilayer stacks/structures. In addition, multilayer stacks/structures disclosed herein can further be used to make pigments for paints and the like.

TABLE 3

| | |
|---|---|
| Refractive Index Materials | Refractive Index Materials |
| (visible region) | (visible region) |

| | Refractive | | Refractive |
|---|---|---|---|
| Material | Index | Material | Index |
| Germanium (Ge) | 4.0-5.0 | Chromium (Cr) | 3.0 |
| Tellurium (Te) | 4.6 | Tin Sulfide (SnS) | 2.6 |
| Gallium Antimonite (GaSb) | 4.5-5.0 | Low Porous Si | 2.56 |
| Indium Arsenide (InAs) | 4.0 | Chalcogenide glass | 2.6 |
| Silicon (Si) | 3.7 | Cerium Oxide (CeO₂) | 2.53 |
| Indium Phosphate (InP) | 3.5 | Tungsten (W) | 2.5 |
| Gallium Arsenate (GaAs) | 3.53 | Gallium Nitride (GaN) | 2.5 |
| Gallium Phosphate (GaP) | 3.31 | Manganese (Mn) | 2.5 |
| Vanadium (V) | 3 | Niobium Oxide (Nb₂O₃) | 2.4 |
| Arsenic Selenide (As₂Se₃) | 2.8 | Zinc Telluride (ZnTe) | 3.0 |
| CuAlSe₂ | 2.75 | Chalcogenide glass + Ag | 3.0 |
| Zinc Selenide (ZnSe) | 2.5-2.6 | Zinc Sulfate (ZnSe) | 2.5-3.0 |
| Titanium Dioxide (TiO₂) - | 2.36 | Titanium Dioxide (TiO₂) - | 2.43 |
| solgel | | vacuum deposited | |
| Alumina Oxide (Al2O3) | 1.75 | Hafnium Oxide (HfO₂) | 2.0 |
| Yttrium Oxide (Y2O3) | 1.75 | Sodium Aluminum Fluoride | 1.6 |
| | | (Na3AlF6) | |
| Polystyrene | 1.6 | Polyether Sulfone (PES) | 1.55 |
| Magnesium Fluoride | 1.37 | High Porous Si | 1.5 |
| (MgF2) | | | |
| Lead Fluoride (PbF2) | 1.6 | Indium Tin Oxide nanorods | 1.46 |
| | | (ITO) | |
| Potassium Fluoride (KF) | 1.5 | Lithium Fluoride (LiF4) | 1.45 |
| Polyethylene (PE) | 1.5 | Calcium Fluoride | 1.43 |
| Barium Fluoride (BaF2) | 1.5 | Strontium Fluoride (SrF2) | 1.43 |
| Silica (SiO2) | 1.5 | Lithium Fluoride (LiF) | 1.39 |
| PMMA | 1.5 | PKFE | 1.6 |
| Aluminum Arsenate (AlAs) | 1.56 | Sodium Fluoride (NaF) | 1.3 |
| Solgel Silica (SiO2) | 1.47 | Nano-porous Silica (SiO2) | 1.23 |
| N,N′ bis(1naphthyl)- | 1.7 | Sputtered Silica (SiO2) | 1.47 |
| 4,4′Diamine (NPB) | | | |
| Polyamide-imide (PEI) | 1.6 | Vacuum Deposited Silica | 1.46 |
| | | (SiO2) | |
| Zinc Sulfide (ZnS) | 2.3 + i(0.015) | Niobium Oxide (Nb₂O₅) | 2.1 |
| Titanium Nitride (TiN) | 1.5 + i(2.0) | Aluminum (Al) | 2.0 + i(15) |
| Chromium (Cr) | 2.5 + i(2.5) | Silicon Nitride (SiN) | 2.1 |
| Niobium Pentoxide(Nb2O5) | 2.4 | Mica | 1.56 |
| Zirconium Oxide (ZrO2) | 2.36 | Polyallomer | 1.492 |
| Hafnium Oxide (HfO2) | 1.9-2.0 | Polybutylene | 1.50 |
| Fluorcarbon (FEP) | 1.34 | Ionomers | 1.51 |
| Polytetrafluro-Ethylene | 1.35 | Polyethylene (Low Density) | 1.51 |
| (TFE) | | | |
| Fluorcarbon (FEP) | 1.34 | Nylons (PA) Type II | 1.52 |
| Polytetrafluro- | 1.35 | Acrylics Multipolymer | 1.52 |
| Ethylene(TFE) | | | |
| Chlorotrifiuoro- | 1.42 | Polyethylene | 1.52 |
| Ethylene(CTFE) | | (Medium Density) | |
| Cellulose Propionate | 1.46 | Styrene Butadiene | 1.52-1.55 |
| | | Thermoplastic | |
| Cellulose Acetate Butyrate | 1.46-1.49 | PVC (Rigid) | 1.52-1.55 |
| Cellulose Acetate | 1.46-1.50 | Nylons (Polyamide) | 1.53 |
| | | Type 6/6 | |
| Methylpentene Polymer | 1.485 | Urea Formaldehyde | 1.54-1.58 |
| Acetal Homopolymer | 1.48 | Polyethylene | 1.54 |
| | | (High Density) | |
| Acrylics | 1.49 | Styrene Acrylonitrile | 1.56-1.57 |
| | | Copolymer | |
| Cellulose Nitrate | 1.49-1.51 | Polystyrene | 1.57-1.60 |
| | | (Heat & Chemical) | |
| Ethyl Cellulose | 1.47 | Polystyrene | 1.59 |
| | | (General Purpose) | |
| Polypropylene | 1.49 | Polycarbornate (Unfilled) | 1.586 |
| Polysulfone | 1.633 | | |

The invention is not restricted to the examples described above. The examples are not intended as limitations on the scope of the invention; and methods, apparatus, compositions, materials, and the like described herein are exemplary and not intended as limitations on the scope of the invention. Changes and other uses will occur to those skilled in the art. As such, the scope of the invention is defined by the scope of the claims.

We claim:

1. A process for designing and manufacturing an omnidirectional structural color (OSC) multilayer stack, the process comprising:
providing a digital processor operable to execute at least one module;
providing a table of index of refraction values corresponding to different materials useable for manufacturing an OSC multilayer stack;
providing an initial design for the OSC multilayer stack, the initial design OSC multilayer stack having at least one layer with an index of refraction selected from the table of index of refraction values;
adding at least one additional layer to the initial design OSC multilayer stack to create a modified OSC multilayer stack, the at least one additional layer having the same or a different index of refraction as the at least one material of the initial design; and
calculating the thickness of each layer of the modified OSC multilayer stack using the merit function module until an optimized OSC multilayer stack has been calculated, the optimized OSC multilayer stack operable to reflect a narrow band of electromagnetic radiation of less than 500 nanometers when viewed from angles between 0 to 45 degrees.

2. The process of claim 1, wherein the modified OSC multilayer stack has a first layer with a first index of refraction and a second layer with a second index of refraction that is not equal to the first index of refraction.

3. The process of claim 2, wherein the modified OSC multilayer stack has a third layer with a third index of refraction that is not equal to the first index of refraction or the second index of refraction.

4. The process of claim 3, further including providing a first, second and third material having the first, second and third indices of refraction, respectively, and manufacturing the OSC multilayer stack with the first, second and third materials having the optimized thicknesses calculated with the merit function module.

5. The process of claim 1, wherein the optimized OSC multilayer stack has 7 or less total layers and reflects at least 75% of the narrow band of electromagnetic radiation as an equivalent 13 layer OSC multilayer stack.

6. The process of claim 5, wherein the optimized OSC multilayer stack has 7 or less total layers and has a chroma within 25% of the equivalent 13 layer OSC multilayer stack.

7. The process of claim 6, wherein the optimized OSC multilayer stack has a chroma within 10% of the equivalent 13 layer OSC multilayer stack.

8. The process of claim 5, wherein the optimized OSC multilayer stack has 7 or less total layers and has a hue shift within 25% of the equivalent 13 layer OSC multilayer stack.

9. The process of claim 8, wherein the optimized OSC multilayer stack has a hue shift within 10% of the equivalent 13 layer OSC multilayer stack.

10. A process for designing and manufacturing an omnidirectional structural color (OSC) multilayer stack, the process comprising:
providing a computer with a digital processor operable to execute a needle optimization module;
providing a table of index of refraction values corresponding to different materials useable for manufacturing an OSC multilayer stack;
providing an initial design for the OSC multilayer stack, the initial design OSC multilayer stack having at least one layer with an index of refraction selected from the table of index of refraction values;
adding at least one additional layer to the initial design OSC multilayer stack using the needle optimization module and creating a modified OSC multilayer stack, the at least one additional layer having a different index of refraction than the at least one layer of the initial design; and
calculating the thickness of each layer of the modified OSC multilayer stack using the needle optimization module until an optimized OSC multilayer stack has been calculated, the optimized OSC multilayer stack having a maximum of 7 total layers and being operable to reflect a narrow band of electromagnetic radiation of less than 500 nanometers when viewed from angles between 0 to 45 degrees with at least 75% reflectance compared to an equivalent 13 layer OSC multilayer stack.

11. The process of claim 10, wherein the modified OSC multilayer stack has a first layer with a first index of refraction and a second layer with a second index of refraction that is not equal to the first index of refraction.

12. The process of claim 11, wherein the modified OSC multilayer stack has a third layer with a third index of refraction that is not equal to the first index of refraction or the second index of refraction.

13. The process of claim 12, further including providing a first, second and third material having the first, second and third indices of refraction, respectively, and manufacturing the OSC multilayer stack with the first, second and third materials having the optimized thicknesses calculated with the merit function module.

14. The process of claim 10, wherein the optimized OSC multilayer stack has 7 or less total layers and reflects at least 75% of the narrow band of electromagnetic radiation compared to an equivalent 13 layer OSC multilayer stack.

15. The process of claim 14, wherein the optimized OSC multilayer stack has 7 or less total layers and has a chroma within 25% of a chroma for the equivalent 13 layer OSC multilayer stack.

16. The process of claim 15, wherein the chroma of the optimized OSC multilayer stack is within 10% of the chroma for the equivalent 13 layer OSC multilayer stack.

17. The process of claim 14, wherein the optimized OSC multilayer stack has 7 or less total layers and has a hue shift within 25% of a hue shift for the equivalent 13 layer OSC multilayer stack.

18. The process of claim 17, wherein the hue shift of the optimized OSC multilayer stack is within 10% of the hue shift for the equivalent 13 layer OSC multilayer stack.

19. A process for designing and manufacturing an omnidirectional structural color (OSC) multilayer stack, the process comprising:
providing a computer with a digital processor operable to execute a needle optimization module;
providing a table of index of refraction values corresponding to different materials useable for manufacturing an OSC multilayer stack;
providing an initial design for the OSC multilayer stack, the initial design OSC multilayer stack having at least one layer with an index of refraction selected from the table of index of refraction values;
adding at least one additional layer to the initial design OSC multilayer stack using the needle optimization module and creating a modified OSC multilayer stack, the modified OSC multilayer stack having a first, second and third layer with a first, second, and third index of refraction, respectively;
calculating the thickness of each layer of the modified OSC multilayer stack using the needle optimization module until an optimized OSC multilayer stack has been calculated, the optimized OSC multilayer stack having a maximum of 7 total layers and being operable to reflect a narrow band of electromagnetic radiation of less than 500 nanometers when viewed from angles between 0 to 45 degrees with at least 75% reflectance compared to an equivalent 13 layer OSC multilayer stack;
providing a first, second and third material having the first, second and third indices of refraction, respectively; and
manufacturing the OSC multilayer stack with the first, second and third materials in the form of the first, second and third layer, respectively and having the optimized thicknesses calculated with the merit function module.

20. The process of claim 19, further including illuminating the manufactured OSC multilayer stack with broad band electromagnetic radiation in the form of white light and reflecting the narrow band of electromagnetic radiation of less than 500 nanometers when viewed from angles between 0 to 45 degrees with the manufactured OSC multilayer stack.
